(19) United States
(12) Patent Application Publication
(10) Pub. No.: US 2026/0197664 A1
(43) Pub. Date: Jul. 9, 2026

(54) TERMINAL DEVICE, METHOD PERFORMED BY TERMINAL DEVICE, AND PROGRAM

(71) Applicant: DENSO CORPORATION, Kariya-city (JP)

(72) Inventor: Terufumi TAKADA, Kariya-city (JP)

(21) Appl. No.: 19/555,350

(22) Filed: Mar. 3, 2026

Related U.S. Application Data
(63) Continuation of application No. PCT/JP2024/031123, filed on Aug. 30, 2024.

(30) Foreign Application Priority Data
Sep. 6, 2023 (JP) 2023-144438

(51) Int. Cl. H04W 16/14; G01S 13/58

(52) U.S. Cl. CPC H04W 16/14; G01S 13/583

(57) ABSTRACT

A terminal device includes a controller and a communicator. The controller and the communicator are configured to perform sensing multiple times by exchanging sensing signals applying any of different beams, different frequencies and different signal sequences in the sensing performed multiple times.

### CROSS-REFERENCE TO RELATED APPLICATION

This application is a continuation application of International Patent Application No. PCT/JP2024/031123, filed Aug. 30, 2024, which designated the U.S. and claims the benefit of priority to Japanese Patent Application No. 2023-144438 filed on Sep. 6, 2023. The entire disclosures of the above applications are incorporated herein by reference.

### TECHNICAL FIELD

The present disclosure relates to a terminal device, a method performed by a terminal device, and a program, and particularly relates to a terminal device for preventing interference of a sensing signal, a method performed by a terminal device, and a program.

### BACKGROUND

The third generation partnership project (3GPP (registered trademark)) defines radio communication specifications referred to as fifth generation New Radio (5G NR), and technical development of the radio specifications is in progress.

Following 5G NR, a 6G system as sixth generation radio communication specifications has started to be studied. In the 6G system, technical specifications related to sensing solutions are under study. In the sensing solutions, a change in a frequency spectrum of a released radio wave is analyzed by using the Doppler effect, and a detection target is thereby detected.

### SUMMARY

In 5G NR, various radio communication specifications are defined. In particular, in order to prevent interference between devices, specifications for allocating resources for transmitting a communication signal are defined. Similarly in the 6G system as well, it is expected that specifications for allocating resources for transmitting a communication signal are to be defined.

In order to implement the sensing solutions described above, it is expected that a large number of terminal devices transmit a sensing signal. It is necessary to prevent a sensing signal transmitted by one terminal device from interfering with a communication signal transmitted from another device and/or a sensing signal transmitted from another device. In particular, in order to enhance accuracy of sensing, it is considered to perform sensing multiple times; however, it is necessary to prevent the above-described interference also in the sensing performed multiple times.

In view of the circumstances described above, the present disclosure provides a technique for preventing interference of a sensing signal and enhancing accuracy of sensing when sensing is performed multiple times.

To achieve the above object, a terminal device according to the present disclosure includes a controller and a communicator, the controller and the communicator are configured to perform sensing multiple times by exchanging sensing signals applying any of different beams, different frequencies and different signal sequences in the sensing performed multiple times.

Further a method implemented by a terminal device includes performing sensing multiple times by exchanging sensing signals applying any of different beams, different frequencies and different signal sequences in the sensing performed multiple times.

According to the configuration described above, when sensing is performed multiple times, a sensing signal transmitted by a terminal device can be prevented from interfering with a sensing signal from another terminal device, and accuracy of sensing can be enhanced. Note that the configurations above may exert, instead of or together with the above advantageous effects, other advantageous effects.

### BRIEF DESCRIPTION OF THE DRAWINGS

FIG. 1 is a diagram illustrating a communication and sensing system S;

FIG. 2 is a diagram illustrating a protocol stack of a U plane;

FIG. 3 is a diagram illustrating a protocol stack of a C plane;

FIG. 4 is a block diagram illustrating a schematic hardware configuration of a terminal device 10;

FIG. 5 is a block diagram illustrating a schematic functional configuration of the terminal device 10;

FIG. 6 is a block diagram illustrating a schematic hardware configuration of a base station device 20;

FIG. 7 is a block diagram illustrating a schematic functional configuration of the base station device 20;

FIG. 8 is a diagram illustrating a radio frame configuration;

FIG. 9 is a diagram illustrating an overview of self-sensing;

FIG. 10 is a diagram illustrating an overview of cooperative-sensing performed by the base station device 20 and the terminal device 10;

FIG. 11 is a diagram illustrating an overview of cooperative-sensing performed by the terminal devices 10;

FIG. 12 is a diagram illustrating an overview of sharing of a sensing beam and a communication beam;

FIG. 13 is a diagram illustrating an overview of sharing of a sensing antenna and a communication antenna;

FIG. 14 is a diagram illustrating an overview of separation of the sensing beam from the communication beam;

FIG. 15 is a diagram illustrating an overview of separation of the sensing antenna from the communication antenna;

FIG. 16 is a diagram illustrating an overview of separation of sensing resources from communication resources in a time domain;

FIG. 17 is a diagram illustrating an overview of separation of the sensing resources from the communication resources in a frequency domain;

FIG. 18 is a diagram illustrating an overview of separation of the sensing resources from the communication resources in a code domain;

FIG. 19 is a diagram illustrating an overview of separation of the sensing resources in the frequency domain/code domain;

FIG. 20 is a diagram illustrating an overview of separation of the sensing resources in the time domain/code domain;

FIG. 21 is a diagram illustrating an overview of separation of the sensing resources in the time domain/frequency domain;

FIG. 22 is a diagram illustrating an overview of allocation of sensing IDs;

FIG. 23 is a diagram illustrating a relationship between the communication resources and the sensing resources in the time domain;

FIG. 24 is a diagram illustrating another relationship between the communication resources and the sensing resources in the time domain;

FIG. 25 is a flowchart illustrating processing of a sensing procedure including self-sensing;

FIG. 26 is a flowchart illustrating other processing of a sensing procedure including self-sensing;

FIG. 27 is a flowchart illustrating processing of a sensing procedure including cooperative-sensing;

FIG. 28 is a flowchart illustrating other processing of a sensing procedure including cooperative-sensing;

FIG. 29 is a diagram illustrating a transmission period and a non-transmission period within the time domain of the sensing resources;

FIG. 30 is a diagram illustrating an overview of processing of generating a signal waveform by inserting the non-transmission period;

FIG. 31 is a diagram illustrating an overview of other processing of generating a signal waveform by inserting the non-transmission period;

FIG. 32 is a diagram illustrating a relationship between the communication resources and the sensing resources in the time domain before time domain periodicity is changed;

FIG. 33 is a diagram illustrating a relationship between the communication resources and the sensing resources in the time domain after the time domain periodicity is changed;

FIG. 34 is a diagram illustrating a relationship between the communication resources and the sensing resources in the time domain after a time domain length is changed;

FIG. 35 is a diagram illustrating a relationship between beams, frequencies, and signal sequences applied when sensing is performed multiple times;

FIG. 36 is a diagram illustrating a relationship between beams, frequencies, and signal sequences applied when sensing is performed multiple times;

FIG. 37 is a diagram illustrating a relationship between beams, frequencies, and signal sequences applied when sensing is performed multiple times;

FIG. 38 is a flowchart illustrating processing of a sensing procedure including cooperative-sensing performed multiple times; and

FIG. 39 is a flowchart illustrating other processing of a sensing procedure including cooperative-sensing performed multiple times.

### DETAILED DESCRIPTION

Hereinafter, embodiments of the present disclosure will be described in detail with reference to the accompanying drawings. Note that, in the Specification and drawings, elements to which similar descriptions are applicable are denoted by the same reference signs, and overlapping descriptions may hence be omitted.

Each embodiment described below is merely an example of a configuration that can implement the present disclosure. Each embodiment described below can be appropriately modified or changed according to a configuration of a device to which the present disclosure is applied and various conditions. All of combinations of elements included in each embodiment described below are not necessarily required to implement the present disclosure, and a part of the elements can be appropriately omitted. Hence, the scope of the present disclosure is not limited by the configuration described in each embodiment described below. Configurations in which a plurality of configurations described in the embodiments below are combined can also be employed unless the configurations are consistent with each other.

### 1. FIRST EMBODIMENT

### 1.1. Communication and Sensing System

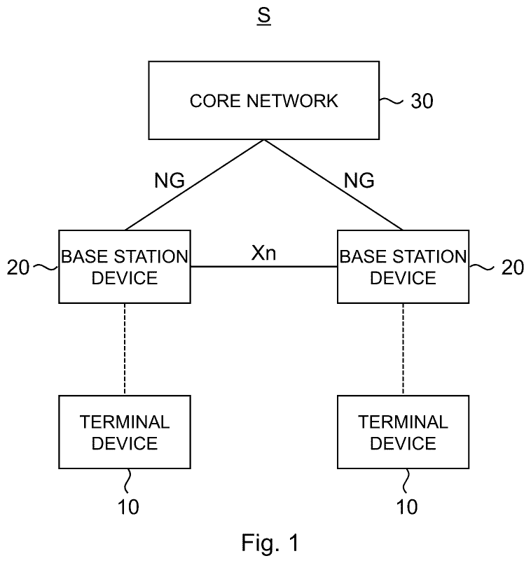

As illustrated in FIG. 1, a communication and sensing system S of a first embodiment includes one or more terminal devices 10, one or more base station devices 20, and a core network 30. The communication and sensing system S is configured according to predetermined technical specifications (TS). For example, the communication and sensing system S may conform to technical specifications (for example, 5G, 5G advanced, 6G, or the like) defined by 3GPP.

In the communication and sensing system S, for example, various radio communications are performed between the terminal device 10 and the base station device 20 according to 5G NR specifications. In the communication and sensing system S, various types of sensing are performed between the terminal device 10 and the base station device 20 or between the terminal devices 10. Details of sensing will be described below.

In the communication and sensing system S, a user plane in which user data is transmitted and received and a control plane in which control data is transmitted and received are separately configured. In other words, the communication and sensing system S supports C/U separation. The user plane is abbreviated to a U plane, and the control plane is abbreviated to a C plane.

The terminal device 10 is a device that performs radio communication with the base station device 20, and may be, for example, a user equipment (UE) that operates according to the 3GPP 5G NR specifications. The terminal device 10 may be a device conforming to other older or newer 3GPP specifications.

The terminal device 10 may be a mobile phone terminal such as a smartphone, a tablet terminal, a notebook PC, a communication module, a communication card, or an IoT device such as a surveillance camera and a robot, for example. The terminal device 10 may be a vehicle (for example, an automobile, a train, or the like), or a device provided thereto. The terminal device 10 may be a transport body (for example, a vessel, an aircraft, or the like) other than a vehicle, or a device provided thereto. The terminal device 10 may be a sensor, or a device provided thereto. Note that the terminal device 10 may be referred to by another term, such as a terminal, a mobile station, a mobile terminal, a mobile device, a mobile unit, a subscriber station, a subscriber terminal, a subscriber device, a subscriber unit, a wireless station, a wireless terminal, a wireless device, a wireless unit, a remote station, a remote terminal, a remote device, and a remote unit. The terminal device 10 may be a device adapted to one or more of enhanced Mobile Broadband (eMBB), Ultra-Reliable and Low Latency Communications (URLLC), and massive Machine Type Communications (mMTC).

The base station device 20 manages at least one cell. The cell constitutes a minimum unit of a communication area. For example, one cell belongs to one frequency (for example, carrier frequency), and includes one component carrier. The term “cell” may represent a radio communication resource, and may represent a communication target of the terminal device 10. The base station device 20 performs radio communication with the terminal device 10 that exists in the cell of the base station device 20 in the U plane and the C plane. In other words, the base station device 20 terminates a U plane protocol and a C plane protocol for the terminal device 10.

The base station device 20 communicates with the core network 30 in the U plane and the C plane. More specifically, the core network 30 includes multiple logical nodes including an access and mobility management function (AMF) and a user plane function (UPF). The base station device 20 connects to the AMF in the C plane, and connects to the UPF in the U plane.

The base station device 20 may be a gNB that provides the U plane and the C plane conforming to the 3GPP 5G NR specifications to the terminal device 10 and connects to a 5G core network (5GC) of 3GPP, for example. The base station device 20 may be a device according to other older or newer 3GPP specifications.

The base station device 20 may include multiple unit devices. For example, the base station device 20 may include a central unit (CU), a distributed unit (DU), and a radio unit (RU).

When multiple base station devices 20 are connected to each other, a radio access network (RAN) is formed. The radio access network formed by the base station devices 20 being gNBs may be referred to as an NG-RAN. The base station device 20 being a gNB may be referred to as an NG-RAN node.

The multiple base station devices 20 are connected to each other by a predetermined interface (for example, an Xn interface). More specifically, for example, the multiple base station devices 20 are connected to each other by an Xn-U interface in the U plane, and are connected to each other by an Xn-C interface in the C plane. Note that the multiple base station devices 20 may be connected to each other by other interfaces having different functions and terms.

Each base station device 20 is connected to the core network 30 by a predetermined interface (for example, an NG interface). More specifically, for example, each base station device 20 is connected to the UPF of the core network 30 by an NG-U interface in the U plane, and is connected to the AMF of the core network 30 by an NG-C interface in the C plane. Note that each base station device 20 may be connected to the core network 30 by other interfaces having different functions and terms.

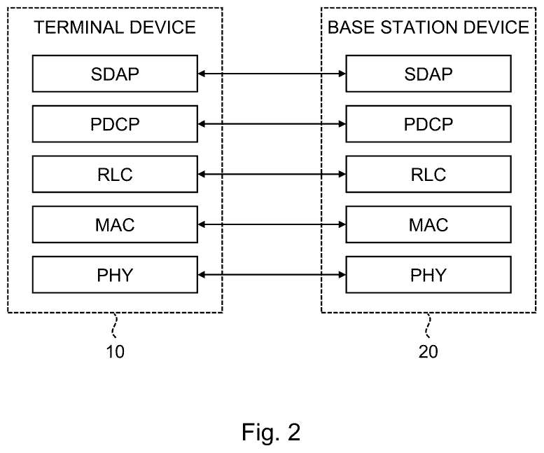

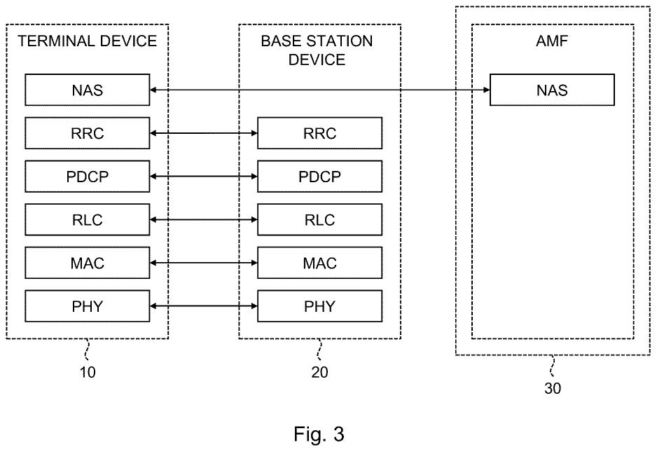

With reference to FIG. 2, radio protocol architecture between the terminal device 10 and the base station device 20 will be described. With reference to FIG. 3, radio protocol architecture between the terminal device 10 and the base station device 20 and between the terminal device 10 and the core network 30 will be described.

As illustrated in FIG. 2, in a protocol stack of the U plane, in order from the lowermost layer, a physical (PHY) layer, a media access control (MAC) layer, a radio link control (RLC) layer, a packet data convergence protocol (PDCP) layer, and a service data adaptation protocol (SDAP) layer are provided. Each of the layers is terminated in the base station device 20 on the network side.

As illustrated in FIG. 3, in a protocol stack of the C plane, in order from the lowermost layer, a physical (PHY) layer, a media access control (MAC) layer, a radio link control (RLC) layer, a packet data convergence protocol (PDCP) layer, a radio resource control (RRC) layer, and a non-access stratum (NAS) are provided. Each of the layers, except the non-access stratum, is terminated in the base station device 20 on the network side. The non-access stratum is terminated in the AMF of the core network 30 on the network side.

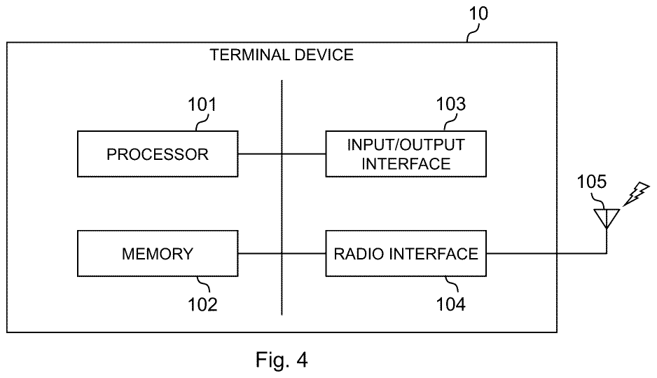

As illustrated in FIG. 4, as hardware elements, the terminal device 10 includes a processor 101, a memory 102, an input/output interface 103, a radio interface 104, and an antenna 105. The above elements provided in the terminal device 10 are connected to each other via an internal bus. Note that the terminal device 10 may include a hardware element other than the elements illustrated in FIG. 4.

The processor 101 is an arithmetic element that implements various functions of the terminal device 10. The processor 101 may be a central processing unit (CPU), a graphics processing unit (GPU), and a system-on-a-chip (SoC) including an element such as a memory controller.

The memory 102 includes at least one storage medium, such as a random access memory (RAM) and an embedded multi media card (eMMC). The memory 102 is an element that temporarily or permanently stores a program and data used to perform various types of processing in the terminal device 10. The program includes one or more instructions for operation of the terminal device 10. The processor 101 deploys the program stored in the memory 102 into the memory 102 and/or an unillustrated system memory and performs the program, to thereby implement the functions of the terminal device 10.

The input/output interface 103 is an interface that receives an operation on the terminal device 10, supplies the operation to the processor 101, and presents various types of information to a user. The input/output interface 103 is a touch panel, for example.

The radio interface 104 is a circuit that performs various types of signal processing for implementing radio communication, and includes a baseband processor and an RF circuit. The radio interface 104 transmits and receives radio signals to and from the base station device 20 via the antenna 105.

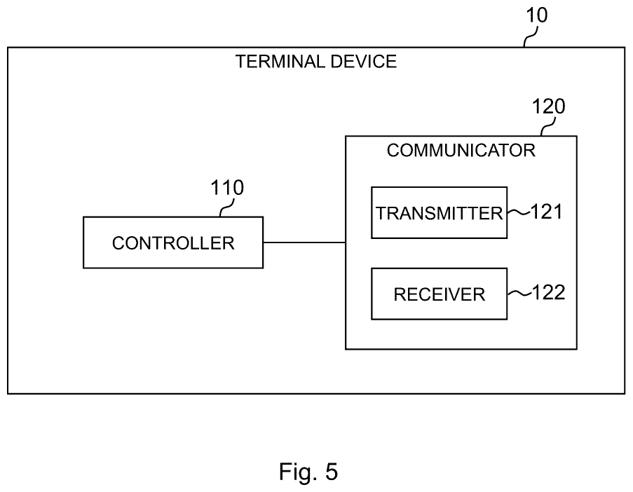

As illustrated in FIG. 5, as functional blocks, the terminal device 10 includes a controller 110 and a communicator 120. The communicator 120 includes at least one transmitter 121 and at least one receiver 122.

The controller 110 may include at least one processor 101 and at least one memory 102. In other words, the controller 110 may be implemented by the processor 101 and the memory 102. The controller 110 performs various types of control processing in the terminal device 10. For example, the controller 110 controls radio communication with the base station device 20 via the communicator 120. In other words, the controller 110 performs transmission and reception of data/information/messages via the communicator 120.

The communicator 120 includes the radio interface 104 and the antenna 105. In other words, the communicator 120 is implemented by the radio interface 104 and the antenna 105. The communicator 120 transmits and receives radio signals to and from the base station device 20, and thereby performs radio communication with the base station device 20. Two or more radio interfaces 104 and two or more antennas 105 may be included in the communicator 120.

When the controller 110 operates, the various types of processing of the terminal device 10 of the present embodiment are performed.

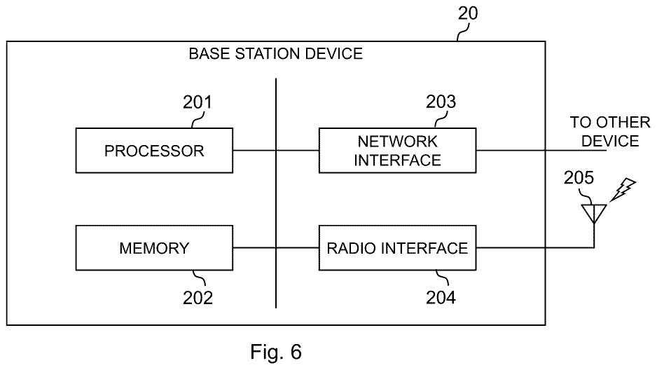

As illustrated in FIG. 6, as hardware elements, the base station device 20 includes a processor 201, a memory 202, a network interface 203, a radio interface 204, and an antenna 205. The above elements provided in the base station device 20 are connected to each other via an internal bus. Note that the base station device 20 may include a hardware element other than the elements illustrated in FIG. 6.

The processor 201 is an arithmetic element that implements various functions of the base station device 20. The processor 201 may be a CPU, and may further include another processor such as a GPU.

The memory 202 includes at least one storage medium, such as a read only memory (ROM), a RAM, a hard disk drive (HDD), and a solid state drive (SSD). The memory 202 is an element that temporarily or permanently stores a program and data used to perform various types of processing in the base station device 20. The program includes one or more instructions for operation of the base station device 20. The processor 201 deploys the program stored in the memory 202 into the memory 202 and/or an unillustrated system memory and performs the program, to thereby implement the functions of the base station device 20.

The network interface 203 is an interface used to transmit and receive signals to and from another base station device 20 and the core network 30.

The radio interface 204 is a circuit that performs various types of signal processing for implementing radio communication, and includes a baseband processor and an RF circuit. The radio interface 204 transmits and receives radio signals to and from the terminal device 10 via the antenna 205.

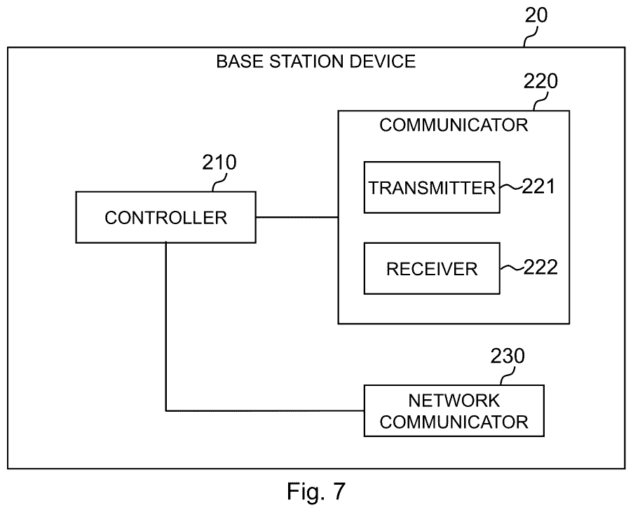

As illustrated in FIG. 7, as functional blocks, the base station device 20 includes a controller 210, a communicator 220, and a network communicator 230. The communicator 220 includes at least one transmitter 221 and at least one receiver 222.

The controller 210 may include at least one processor 201 and at least one memory 202. In other words, the controller 210 may be implemented by the processor 201 and the memory 202. The controller 210 performs various types of control processing in the base station device 20. For example, the controller 210 controls radio communication with the terminal device 10 via the communicator 220. In other words, the controller 210 performs transmission and reception of data/information/messages via the communicator 220. For example, the controller 210 controls communication with another node (for example, another base station device 20, a node of the core network 30) via the network communicator 230.

The communicator 220 includes the radio interface 204 and the antenna 205. In other words, the communicator 220 is implemented by the radio interface 204 and the antenna 205. The communicator 220 transmits and receives radio signals to and from the terminal device 10, and thereby performs radio communication with the terminal device 10. Two or more radio interfaces 204 and two or more antennas 205 may be included in the communicator 220.

The network communicator 230 includes the network interface 203. In other words, the network communicator 230 is implemented by the network interface 203. The network interface 203 transmits and receives signals to and from the network (and another node described above).

When the controller 210 operates, the various types of processing of the base station device 20 of the present embodiment are performed.

### 1.2. Radio Resources

The terminal device 10 and the base station device 20 perform radio communication with each other by using radio resources in a frequency domain and a time domain. The terminal device 10 performs sensing with the terminal device 10 itself, another terminal device 10, and/or the base station device 20 by using radio resources. The radio resources will be described below.

A transmission scheme for downlink communication from the base station device 20 to the terminal device 10 is orthogonal frequency division multiplexing (OFDM) using a cyclic prefix (CP), i.e., CP-OFDM, for example. A transmission scheme for uplink communication from the terminal device 10 to the base station device 20 is CP-OFDM described above, or DFTS-OFDM in which CP-OFDM is applied after transform precoding of performing discrete Fourier transform spreading (DFT spreading), for example. A transmission scheme for a sensing signal may also employ the schemes described above. The sensing signal is transmitted from the base station device 20 to the terminal device 10, or is transmitted between the terminal devices 10.

The cyclic prefix is a redundant signal that functions as a guard period (GP) for preventing inter-symbol interference and inter-carrier interference, and is inserted at the start of an OFDM symbol. As types of cyclic prefixes, a normal cyclic prefix and an extended cyclic prefix are present.

As the radio resources in the frequency domain of OFDM, multiple subcarriers being orthogonal to each other are used. The multiple subcarriers are allocated with a predetermined subcarrier spacing (sub-carrier spacing, SCS) Δf in the frequency domain. In the communication and sensing system S, multiple subcarrier spacings Δf may be applied. The subcarrier spacing Δf is expressed by the following expression, for example.

Δf=2^{μ}·15 [kHz]

Here, μ is an integer of 0 or greater, and may take at least one of values of 0, 1, 2, 3, 4, 5, and 6. Accordingly, the subcarrier spacing Δf [KHz] may take at least one of values of 15, 30, 60, 120, 240, 480, and 960. Note that μ may take a value of 7 or greater.

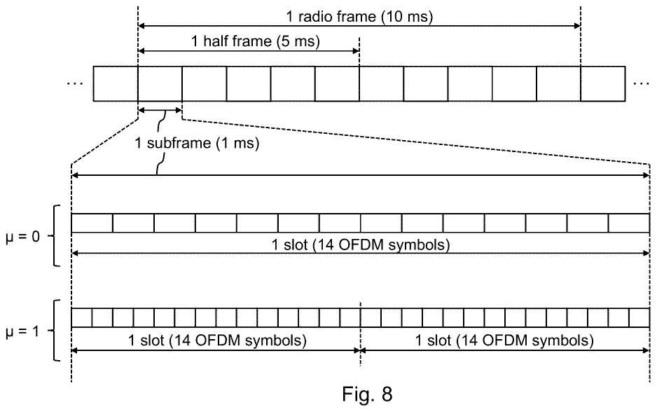

In the time domain of OFDM, as illustrated in FIG. 8, a hierarchical radio frame configuration is used. One radio frame includes 10 subframes. The subframes are assigned subframe numbers from 0 to 9, which are counted up by 1. One radio frame is divided into two half frames. A time length of the radio frame is 10 ms, a time length of the half frame is 5 ms, and a time length of the subframe is 1 ms. The above time lengths do not depend on the subcarrier spacing Δf.

One subframe includes one or more slot(s). The number Ns of slots included in one subframe depends on the value of u described above, and thus on the subcarrier spacing Δf. The number Ns of slots is expressed by the following expression, for example.

Ns=2^{μ}

One slot includes multiple symbols. The number of symbols included in one slot depends on the type of cyclic prefix. For example, when the normal cyclic prefix is used, one slot includes 14 symbols. For example, when the extended cyclic prefix is used, one slot includes 12 symbols.

As described above, the number of slots and the number of symbols included in each of the radio frame, the half frame, and the subframe having fixed time lengths are variable. Accordingly, the time length of the slot and the time length of the symbol are also variable.

A resource element (RE) is a radio resource unit in the time-frequency domain including one subcarrier and one symbol. A resource block (RB) is a radio resource unit in the time-frequency domain including 12 subcarriers and multiple symbols.

The radio frames are assigned system frame numbers (SFNs) from 0 to 1023, which are counted up by 1. The SFN “0” corresponds to an initial value of the SFN, and the SFN “1023” corresponds to a maximum value of the SFN. Accordingly, a radio frame that is subsequent to a radio frame assigned the SFN 1023 is assigned the SFN 0. Because the time length of the radio frame is 10 ms, the time length of one cycle of the system frame numbers is 10240 ms (=10.24 seconds).

Here, the base station device 20 may configure one or multiple serving cells for the terminal device 10. The serving cell may correspond to a component carrier in the downlink and/or a component carrier in the uplink. A technique in which one or multiple serving cells are configured and the base station device 20 and the terminal device 10 perform radio communication may also be referred to as carrier aggregation.

The base station device 20 may configure one or multiple bandwidth parts (BWPs) for the terminal device 10 for each of the one or multiple serving cells. For example, a downlink bandwidth part (DL-BWP) may be configured in the downlink of one serving cell. An uplink bandwidth part (UL-BWP) may be configured in the uplink of one serving cell. Here, the DL-BWP may include an initial DL-BWP and/or a dedicated DL-BWP. The UL-BWP may include an initial UL-BWP and/or a dedicated UL-BWP. In the following, the BWP may include the DL-BWP and/or the UL-BWP.

### 1.3. Channels and Control Information

The terminal device 10 and the base station device 20 transmit and receive user data and control information to and from each other. An example of transmission and reception of downlink and uplink control information will be described below.

The terminal device 10 and the base station device 20 transmit and receive user data and control information by using multiple hierarchical channels. Physical channels are channels used for physical communication between the terminal device 10 and the base station device 20. Examples of the physical channels include a physical downlink control channel (PDCCH), a physical broadcast channel (PBCH), and a physical uplink control channel (PUCCH).

Transport channels are channels located higher than the physical channels, and are mapped to the physical channels in the PHY layer. Multiple transport channels may be mapped to one physical channel. Examples of the transport channels include a downlink shared channel (DL-SCH) and an uplink shared channel (UL-SCH). For example, data in the downlink is also referred to as data of the DL-SCH. For example, data in uplink may also be referred to as data of the UL-SCH. Here, the data of the DL-SCH includes user data in the downlink. The data of the UL-SCH includes user data in the uplink.

Logical channels are channels located higher than the transport channels, and are mapped to the transport channels in the MAC layer. Multiple logical channels may be mapped to one transport channel, and one logical channel may be mapped to multiple transport channels. The logical channels are classified by features of information to be transmitted. Examples of the logical channels include a broadcast control channel (BCCH), a common control channel (CCCH), and a dedicated control channel (DCCH).

The base station device 20 transmits downlink control information (DCI) to the terminal device 10 by using the PDCCH being a physical channel. The DCI includes information related to downlink and uplink resource allocation for the terminal device 10 and control information of the terminal device 10. The DCI is mapped to the PDCCH, and corresponds to layer-1 signaling.

Here, one or multiple formats may be defined for transmission of the DCI on the PDCCH. The formats defined for transmission of the DCI on the PDCCH may be referred to as DCI formats. For example, the DCI formats may include DCI formats (for example, formats referred to as DCI format 1_0, DCI format 1_1, and/or DCI format 1_2) used for scheduling of a physical downlink shared channel (PDSCH). For example, the DCI formats may include DCI formats (for example, formats referred to as DCI format 0_0, DCI format 0_1, and/or DCI format 0_2) used for scheduling of a physical uplink shared channel (PUSCH). The DCI formats may include DCI formats not used for scheduling of the PDSCH and/or the PUSCH. The DCI formats used for scheduling of the PDSCH and/or the PUSCH may be referred to as scheduling DCI formats. The DCI formats not used for scheduling of the PDSCH and/or the PUSCH may be referred to as non-scheduling DCI formats. In the present embodiment, for the sake of simplicity of description, the “DCI format” may be simply referred to as the “PDCCH”. The “DCI generated according to the DCI format” may be simply referred to as the “DCI format”.

For example, the base station device 20 may configure frequency-domain resources and/or time-domain resources for the terminal device 10 to monitor a candidate set of the PDCCH. For example, the frequency-domain resources for the terminal device 10 to monitor the candidate set of the PDCCH may be referred to as a control resource set (CORESET). The time-domain resources for the terminal device 10 to monitor the candidate set of the PDCCH may be referred to as a search space set (SSS). The terminal device 10 may monitor the candidate set of the PDCCH in one or multiple CORESETs in the DL-BWP of the serving cell configured with PDCCH monitoring according to a corresponding search space set. Here, to monitor may connote to attempt to decode each of the PDCCH candidates according to the monitored DCI format. The above configuration may be referred to as blind decoding.

Here, a cyclic redundancy check (CRC) scrambled with a radio network temporary identifier (RNTI) may be added to the DCI (or the DCI format) to be transmitted on the PDCCH. The CRC may also be referred to as CRC parity bits. Multiple types of RNTIs are defined. For example, the base station device 20 may configure each RNTI by transmitting an RRC message including at least one of information indicating a cell-RNTI (C-RNTI), information indicating a modulation and coding scheme cell-RNTI (MCS-C-RNTI), and information indicating a configured scheduling-RNTI (CS-RNTI). In other words, a CRC scrambled with at least one of the C-RNTI, the MCS-C-RNTI, and the CS-RNTI may be added to the DCI (or the DCI format) to be transmitted on the PDCCH.

The terminal device 10 may monitor (and/or receive) the PDCCH, and detect (and/or receive) the DCI format.

The terminal device 10 transmits uplink control information (UCI) to the base station device 20 by using the PUCCH being a physical channel. The UCI includes control information such as a scheduling request (SR), an Ack/Nack of a hybrid automatic repeat request (HARQ), and channel state information (CSI). The UCI is mapped to the PUCCH or the PUSCH, and corresponds to layer-1 signaling.

The base station device 20 transmits a control element (CE) of the MAC layer to the terminal device 10 by using the DL-SCH being a transport channel. The downlink MAC CE is mapped to the PDSCH via the DL-SCH, and corresponds to layer-2 signaling.

The terminal device 10 transmits a control element (CE) of the MAC layer to the base station device 20 by using the UL-SCH being a transport channel. The uplink MAC CE includes control information such as a buffer status report (BSR). The uplink MAC CE is mapped to the PUSCH via the UL-SCH, and corresponds to layer-2 signaling.

The base station device 20 transmits (or broadcasts) system information (SI) to the terminal device 10 by using the BCCH being a logical channel. The SI includes minimum system information (MSI) and other system information (OSI). The MSI includes a master information block (MIB) and a system information block 1 (SIB1). The SIB1 may be referred to as remaining minimum system information (RMSI). The OSI includes system information blocks (SIB2 and so on) other than the SIB1. Of the BCCH, the MIB is mapped to the PBCH via a broadcast channel (BCH), and the SIB is mapped to the PDSCH via the DL-SCH.

The base station device 20 transmits control information in the RRC layer to the terminal device 10 by using a signaling radio bearer (SRB) established between the terminal device 10 and the base station device 20 in the RRC layer. A message exchanged between the base station device 20 and the terminal device 10 in the RRC layer may be hereinafter referred to as an RRC message. Multiple types of SRBs (for example, SRB0, SRB1, SRB2, SRB3, and SRB4) are present. The SRBs are used to transmit and receive a NAS message including control information in the NAS layer, other than the RRC message. The CCCH or the DCCH is used to transmit the RRC message from the base station device 20 to the terminal device 10. The CCCH and the DCCH are each mapped to the PDSCH via the DL-SCH. The RRC message corresponds to layer-3 signaling.

As an example of a downlink RRC message, an RRC reconfiguration (RRCReconfiguration) message will be described. The RRC reconfiguration message is an RRC message transmitted from the base station device 20 to the terminal device 10 by using the SRB1 or the SRB3. The DCCH is used to transmit the RRC reconfiguration message. The RRC reconfiguration message is used to perform reconfiguration or modification related to connection between the base station device 20 and the terminal device 10.

The terminal device 10 transmits the RRC message to the base station device 20 by using the SRB described above. The CCCH or the DCCH is used to transmit the RRC message from the terminal device 10 to the base station device 20. The CCCH and the DCCH are each mapped to the PUSCH via the UL-SCH. The RRC message corresponds to layer-3 signaling.

As an example of an uplink RRC message, a user equipment capability information (UECapabilityInformation) message will be described. The user equipment capability information message is an RRC message transmitted from the terminal device 10 to the base station device 20 by using the SRB1. The DCCH is used to transmit the user equipment capability information message. The user equipment capability information message is used to notify the base station device 20 of information related to a radio access capability of the terminal device 10.

As an example of an uplink RRC message, a user equipment assistance information (UEAssistanceInformation) message will be described. The user equipment assistance information message is an RRC message transmitted from the terminal device 10 to the base station device 20 by using the SRB1 or the SRB3. The DCCH is used to transmit the user equipment assistance information message. The user equipment assistance information message is used to notify the base station device 20 of various types of information (UE assistance information) related to the terminal device 10.

### 1.4. Sensing

### 1.4.1. Sensing Channel and Sensing Signal

As described above, the terminal device 10 performs sensing with the terminal device 10 itself, another terminal device 10, and/or the base station device 20. In sensing, radio waves transmitted toward an object to be detected, such as a person or an obstruction, are received, a change in a frequency spectrum of the radio waves is analyzed, and thereby the object is detected. The object to be detected by sensing is hereinafter referred to as a “detection target”. The detection target includes a person, an animal, an object, and the like to be detected.

In the present embodiment, a sensing channel and/or a sensing signal defined separately from radio communication is used for the radio waves used for performing sensing. In this manner, a communication channel/communication signal can be separated from the sensing channel/sensing signal. In the following, in the present embodiment, the “sensing signal” is used for performing sensing. The sensing signal may be used exchangeably with the sensing channel.

Regarding sensing, as will be described below, in a case of self-sensing, the same device serves as a sensing transmitting device and a sensing receiving device, the sensing transmitting device transmits a sensing signal, and the sensing receiving device receives the sensing signal. In a case of cooperative-sensing, one of different devices serves as a sensing transmitting device, the other device serves as a sensing receiving device, the sensing transmitting device transmits a sensing signal, and the sensing receiving device receives the sensing signal. In either case, sensing is performed by exchanging sensing signals.

### 1.4.2. Sensing Transmitting Device and Sensing Receiving Device

For example, when sensing is performed between two terminal devices 10, one of the two terminal devices 10 transmits a sensing signal, and the other terminal device 10 receives the sensing signal. The sensing signal is reflected from a detection target, and has its frequency spectrum changed due to the Doppler effect. The terminal device 10 that has received the sensing signal analyzes the change in the frequency spectrum of the sensing signal, and detects the detection target. In the following, in order to distinguish among multiple terminal devices, of the multiple terminal devices, a first one is referred to as a “first terminal device 10”, a second one is referred to as a “second terminal device 10”, and a third one is referred to as a “third terminal device 10”.

A device that transmits a sensing signal is referred to as a sensing transmitting device. The sensing transmitting device may be one of the terminal device 10 and the base station device 20. A device that receives a sensing signal is referred to as a sensing receiving device. The sensing receiving device may be the terminal device 10, and may be the base station device 20 in some cases.

### 1.4.3. Self-Sensing

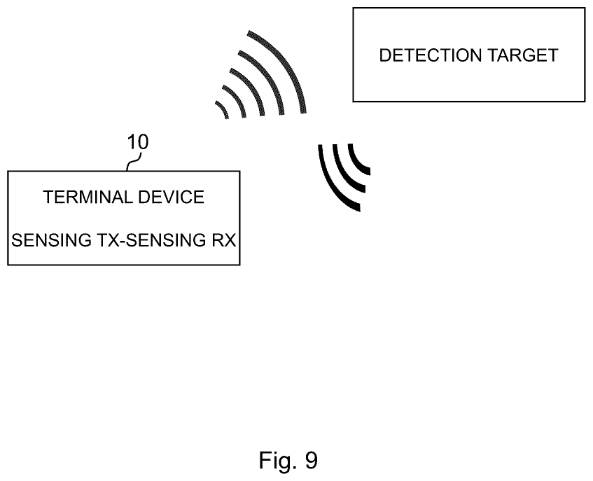

When one terminal device 10 performs sensing, the terminal device 10 serves as both of the sensing transmitting device and the sensing receiving device. As illustrated in FIG. 9, the terminal device 10 serves as both of the sensing transmitting device and the sensing receiving device. In this case, the terminal device 10 transmits a sensing signal as the sensing transmitting device, and receives the sensing signal reflected from a sensing target, a wall, and/or the like as the sensing receiving device. In this manner, sensing performed by one device serving as both of the sensing transmitting device and the sensing receiving device is referred to as “self-sensing”. Self-sensing may be used exchangeably with monostatic-sensing and single-sensing.

### 1.4.4. Cooperative-Sensing

For example, when two or more terminal devices 10 perform sensing, the first terminal device 10 serves as the sensing transmitting device, and the second terminal device 10 serves as the sensing receiving device. In this case, the first terminal device 10 transmits a sensing signal, and the second terminal device 10 receives the sensing signal. In this manner, sensing performed by multiple devices is referred to as “cooperative-sensing”. Cooperative-sensing may be used exchangeably with group-sensing, collaborative-sensing, bistatic-sensing, and multistatic-sensing.

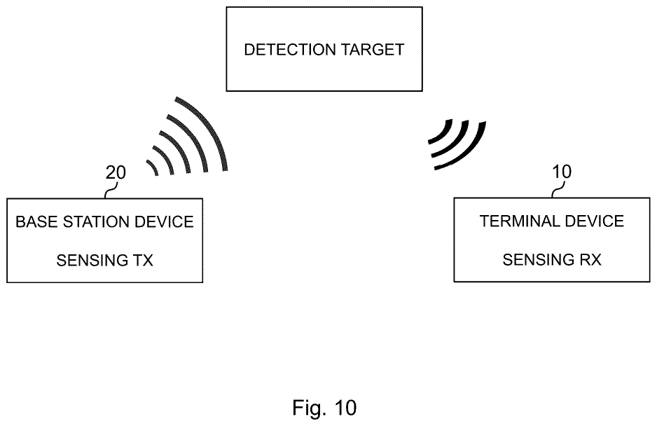

In cooperative-sensing, for example, the base station device 20 may serve as the sensing transmitting device, and the terminal device 10 may serve as the sensing receiving device. As illustrated in FIG. 10, the base station device 20 serves as the sensing transmitting device, and the terminal device 10 serves as the sensing receiving device. In this case, the base station device 20 transmits a sensing signal to a detection target, and the terminal device 10 receives the sensing signal.

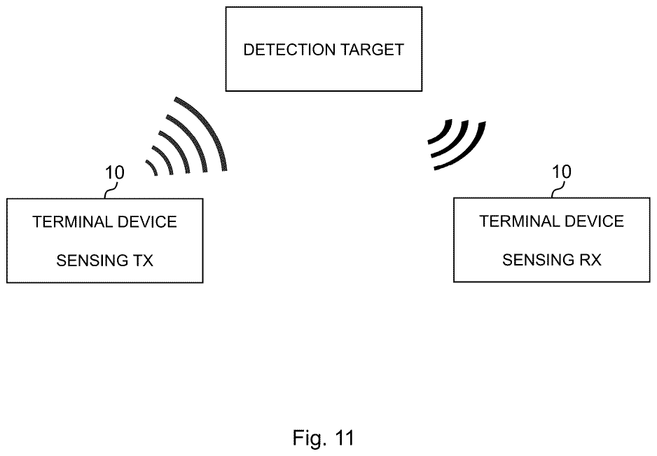

In cooperative-sensing, for example, the first terminal device 10 may serve as the sensing transmitting device, and the second terminal device 10 and the third terminal device 10 may serve as the sensing receiving devices. As illustrated in FIG. 11, the first terminal device 10 serves as the sensing transmitting device, and the second terminal device 10 serves as the sensing receiving device. In this case, the first terminal device 10 transmits a sensing signal to a detection target, and the second terminal device 10 receives the sensing signal.

Cooperative-sensing may be performed by three or more devices. For example, two terminal devices 10 may serve as the sensing transmitting devices, and one terminal device 10 may serve as the sensing receiving device. In this case, the two terminal devices 10 as the sensing transmitting devices each transmit a sensing signal, and the one terminal device 10 as the sensing receiving device receives the sensing signal.

One terminal device 10 may serve as the sensing transmitting device, and two terminal devices 10 may serve as the sensing receiving devices. In this case, the one terminal device 10 as the sensing transmitting device transmits a sensing signal, and the two terminal devices 10 as the sensing receiving devices each receive the sensing signal. The ratio between the number of sensing transmitting devices and the number of sensing receiving devices when three or more devices perform cooperative-sensing may be N to M, where N and M are each an integer of 1 or greater.

### 1.4.5. Sensing Initiator and Sensing Responder

For example, the base station device 20 may request the terminal device 10 to perform sensing. In this case, the base station device 20 transmits a sensing request message to the terminal device 10, and the terminal device 10 transmits an ACK message to the base station device 20. Through such a procedure, sensing is performed by the terminal device 10 and the base station device 20. The first terminal device 10 may request the second terminal device 10 to perform sensing. In this case, the first terminal device 10 transmits a sensing request message to the second terminal device 10, and the second terminal device 10 transmits an ACK message to the first terminal device 10. Through such a procedure, sensing is performed by the first terminal device 10 and the second terminal device 10.

A device that requests performing of sensing is referred to as a “sensing initiator”. A device that performs sensing in response to the request from the sensing initiator is referred to as a “sensing responder”. The sensing initiator may be used exchangeably with a “sensing requester”.

A procedure for starting sensing, such as the sensing initiator transmitting the sensing request message and the sensing responder transmitting the ACK message described above, is referred to as a “sensing start procedure”.

For example, the base station device 20 may serve as the sensing initiator, and the terminal device 10 may serve as the sensing responder. In this case, cooperative-sensing may be performed with the base station device 20 as the sensing transmitting device and the terminal device 10 as the sensing receiving device in response to the request from the base station device 20. Self-sensing may be performed with the terminal device 10 as the sensing transmitting device and the sensing receiving device in response to the request from the base station device 20.

The base station device 20 may serve as the sensing initiator, and the first terminal device 10 and the second terminal device 10 may serve as the sensing responders. In this case, cooperative-sensing may be performed with the base station device 20 as the sensing transmitting device and the first terminal device 10 and the second terminal device 10 as the sensing receiving devices in response to the request from the base station device 20. Cooperative-sensing may be performed with the first terminal device 10 as the sensing transmitting device and the second terminal device 10 as the sensing receiving device in response to the request from the base station device 20.

The first terminal device 10 may serve as the sensing initiator, and the second terminal device may serve as the sensing responder. In this case, cooperative-sensing may be performed with the first terminal device 10 as the sensing transmitting device and the second terminal device 10 as the sensing receiving device in response to the request from the first terminal device 10. Cooperative-sensing may be performed with the second terminal device 10 as the sensing transmitting device and the first terminal device 10 as the sensing receiving device in response to the request from the first terminal device 10. Furthermore, self-sensing may be performed with the second terminal device 10 as the sensing transmitting device and the sensing receiving device in response to the request from the first terminal device 10.

### 1.5. Transmit Beams and Antennas

### 1.5.1. Sharing of Sensing Beam and Communication Beam

For example, when the terminal device 10 serves as the sensing transmitting device, the terminal device 10 forms a beam for transmitting the sensing signal. When the terminal device 10 performs radio communication, the terminal device 10 forms a beam for transmitting the communication signal. In the following, a beam used for radio communication is referred to as a “communication beam”, and a beam used for sensing is referred to as a “sensing beam”.

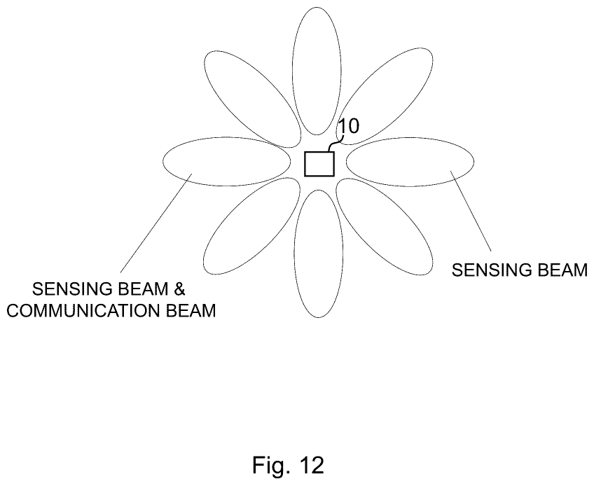

The same beam may be used for both of the sensing beam and the communication beam. For example, as illustrated in FIG. 12, among multiple beams, some beams may be used as the sensing beams, and other beams may be used as both of the sensing beam and the communication beam. The sensing beam and the communication beam may be identified and switched using antenna ports and indices.

### 1.5.2. Sharing of Sensing Antenna and Communication Antenna

The same antenna may be used for an antenna for transmitting the sensing signal and an antenna for transmitting the communication signal. In the following, an antenna used for radio communication is referred to as a “communication antenna”, and an antenna used for sensing is referred to as a “sensing antenna”.

For example, multiple antenna panels may be used. In this manner, multiple beams can be simultaneously transmitted. In this case, for example, any one antenna panel of the multiple antenna panels may be used as the sensing antenna, and other antenna panels of the multiple antenna panels may be used as both of the sensing antenna and the communication antenna.

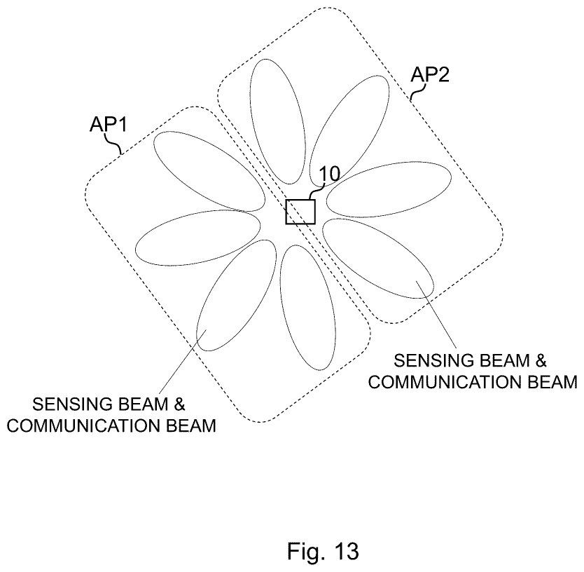

As illustrated in FIG. 13, for example, beams transmitted from an antenna panel AP1 installed on one side of the terminal device 10 may be used as both of the sensing beam and the communication beam. Beams transmitted from an antenna panel AP2 installed on another side of the terminal device 10 may be used as both of the sensing beam and the communication beam. Owing to such a configuration, for example, by simultaneously transmitting and receiving the sensing beam from the antenna panel AP1 and transmitting and receiving the communication beam from the antenna panel AP2, the sensing beam and the communication beam can be simultaneously transmitted and received. By simultaneously transmitting and receiving the sensing beam from the antenna panel AP1 and transmitting and receiving the sensing beam from the antenna panel AP2, multiple sensing beams can be simultaneously transmitted and received.

1.5.3. Separation of Sensing Beam from Communication Beam

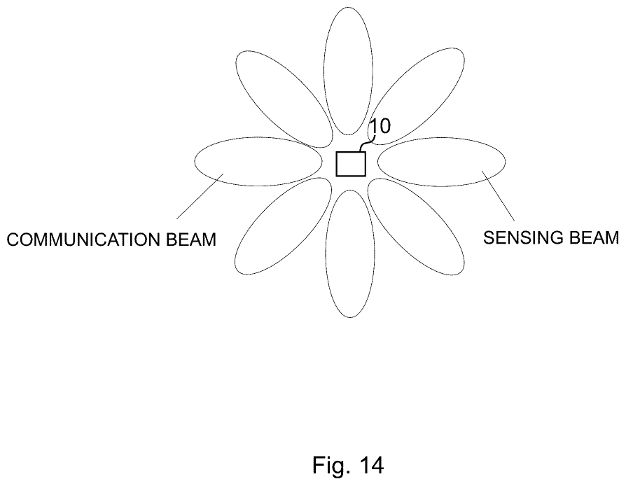

Different beams may be used for the sensing beam and the communication beam. For example, as illustrated in FIG. 14, among multiple beams, some beams may be used as the sensing beams, and other beams may be used as the communication beams. The sensing beam and the communication beam may be switched using antenna ports and indices.

By using different beams for the sensing beam and the communication beam, the sensing beam can be separated from the communication beam. A range in which the communication signal is transmitted in radio communication and a range in which the sensing signal is transmitted in sensing may be different overall. In radio communication, beam sweeping is used to widen a signal transmission range. For example, when the range for transmitting the sensing signal is overall narrower than the range for transmitting the communication signal, beam sweeping need not be frequently performed for transmitting the sensing signal as compared to when transmitting the communication signal. By separating the sensing beam from the communication beam, such a case can be flexibly coped with.

1.5.4. Separation of Sensing Antenna from Communication Antenna

Different antennas may be used for the antenna for transmitting the sensing signal and the antenna for transmitting the communication signal.

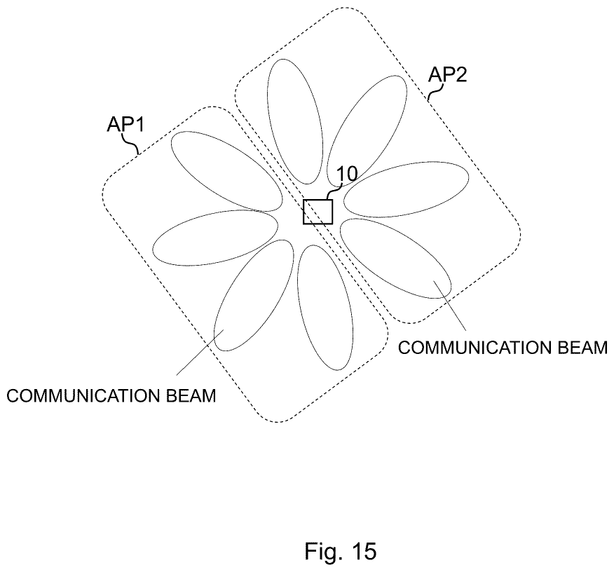

As illustrated in FIG. 15, for example, beams transmitted from the antenna panel AP1 installed on one side of the terminal device 10 may be used as the sensing beams. Beams transmitted from the antenna panel AP2 installed on other side of the terminal device 10 may be used as the communication beams. Owing to such a configuration, for example, by simultaneously transmitting and receiving the sensing beam from the antenna panel AP1 and transmitting and receiving the communication beam from the antenna panel AP2, the sensing beam and the communication beam can be simultaneously transmitted and received.

As described above, the range for transmitting the communication signal in radio communication and the range for transmitting the sensing signal in sensing may be different overall. When the range for transmitting the communication signal is overall wider than the range for transmitting the sensing signal, it may be preferable to configure only the communication antenna as an omni-directional antenna. By separating the sensing antenna from the communication antenna, such a case can be flexibly coped with.

1.6. Separation of Sensing Resources from Communication Resources

Resources used for transmitting the sensing signal are separated from resources used for transmitting the communication signal in the time domain/frequency domain/code domain. In the following, a resource used for radio communication is referred to as a “communication resource”, and a resource used for sensing is referred to as a “sensing resource”. By separating the sensing resources from the communication resources, at least interference between the sensing signal and the communication signal can be avoided.

### 1.6.1. Time Division Multiplexing

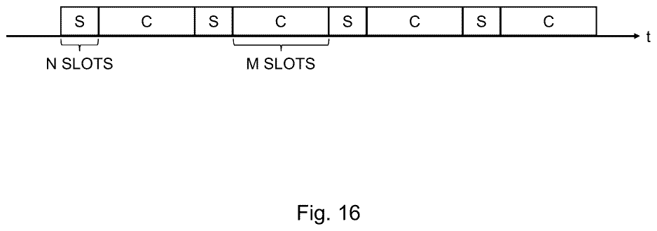

The sensing resources may be separated from the communication resources in the time domain. As illustrated in FIG. 16, the time domain of the sensing resources and the time domain of the communication resources are alternately allocated with certain periodicity. In FIG. 16, the time domain of the sensing resources is represented by “S”, and the time domain of the communication resources is represented by “C”.

The time domain of the sensing resources may be a time interval of N slots, where Nis an integer of 1 or greater, for example. The time domain of the communication resources may be a time interval of M slots, where M is an integer of 1 or greater, and N>M, N=M, or N<M may hold, for example. Note that, in the present embodiment, the sensing resources and the communication resources are allocated in units of slots, but may be allocated in units of frames, subframes, or other time units, instead of slots.

When the sensing resources are separated from the communication resources in the time domain, the base station device 20 may transmit information related to the time domain of the sensing resources to the terminal device 10. The information related to the time domain may be transmitted using an RRC message or a message of another layer such as a MAC CE, for example.

The information related to the time domain includes information for identifying the time domain of the sensing resources. For example, the information related to the time domain may include an interval at which the time domain of the sensing resources is inserted with respect to the communication resources. For example, when there are 20 slots in one frame and the time domain of the sensing resources is inserted every three slots within one frame, the interval at which the time domain of the sensing resources is inserted is 3 (slots). The interval at which the time domain of the sensing resources is inserted may be referred to as “time domain periodicity”.

The information related to the time domain may include an offset. The offset is a time difference in units of slots at which the time domain of the sensing resources starts with reference to a starting point of a frame. For example, when the time domain of the sensing resources starts two slots after a starting point of a frame, the offset is 2 (slots).

Furthermore, the information related to the time domain may include a length of the time domain of the sensing resources. For example, when the time domain of the sensing resources has the five slots, the length of the time domain of the sensing resources is 5 (slots). The length of the time domain of the sensing resources may be referred to as a “time domain length”.

### 1.6.2. Frequency Division Multiplexing

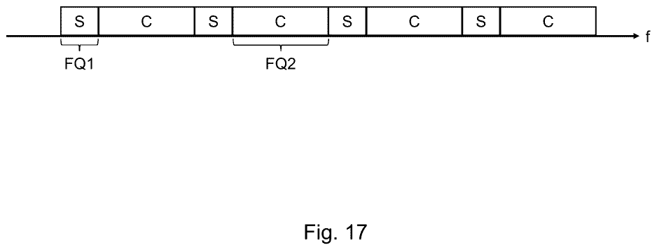

The sensing resources may be separated from the communication resources in the frequency domain. As illustrated in FIG. 17, the frequency domain of the sensing resources and the frequency domain of the communication resources are alternately allocated for each subcarrier or block. In FIG. 17, the frequency domain of the sensing resources is represented by “S”, and the frequency domain of the communication resources is represented by “C”. The frequency domain of the sensing resources may be a frequency band allocated for each subcarrier or block, and the frequency band is represented by FQ1. The frequency domain of the communication resources may be a frequency band allocated for each subcarrier or block, and the frequency band is represented by FQ2.

When the sensing resources are separated from the communication resources in the frequency domain, the base station device 20 may transmit information related to the frequency domain of the sensing resources to the terminal device 10. The information related to the frequency domain may be transmitted using an RRC message or a message of another layer such as a MAC CE, for example.

The information related to the frequency domain includes information for identifying the frequency domain of the sensing resources. For example, the information related to the frequency domain may include an interval at which the frequency domain of the sensing resources is inserted with respect to the communication resources. For example, when the communication resources are allocated to three consecutive subcarriers among four consecutive subcarriers and the sensing resources are allocated to one subcarrier, the interval at which the frequency domain of the sensing resources is inserted is 4 (subcarriers). The interval at which the frequency domain of the sensing resources is inserted may be referred to as a “frequency domain interval”.

The information related to the frequency domain may include a frequency bandwidth used for the frequency domain of the sensing resources.

### 1.6.3. Code Division Multiplexing

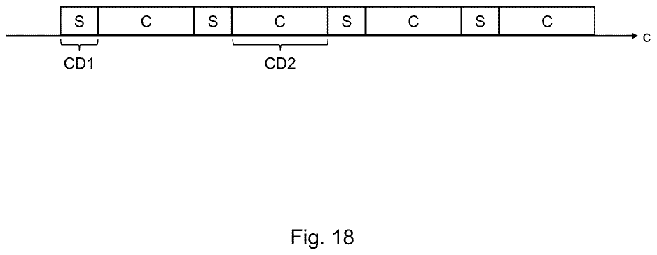

The sensing resources may be separated from the communication resources in the code domain. As illustrated in FIG. 18, the code domain of the sensing resources and the code domain of the communication resources are alternately allocated by applying a different code for each subcarrier or block. The applied code may be a ZC sequence or a DFTS-OFDM sequence, for example. In FIG. 18, the code domain of the sensing resources is represented by “S”, and the code domain of the communication resources is represented by “C”.

The code domain of the sensing resources may be a domain to which an orthogonal code or a non-orthogonal code is applied for each subcarrier or block, and the domain to which the code is applied is represented by CD1. The code domain of the communication resources may be a domain to which an orthogonal code or a non-orthogonal code is applied for each subcarrier or block, and the domain to which the code is applied is represented by CD2.

When the sensing resources are separated from the communication resources in the code domain, the base station device 20 may transmit information related to the code domain of the sensing resources to the terminal device 10. The information related to the code domain may be transmitted using an RRC message or a message of another layer such as a MAC CE, for example.

The information related to the code domain includes information for identifying the code domain of the sensing resources. For example, the information related to the code domain may include an interval at which the code domain of the sensing resources is inserted with respect to the communication resources. For example, when the codes for the communication resources are applied to three consecutive subcarriers among four consecutive subcarriers and the codes for the sensing resources are applied to one subcarrier, the interval at which the code domain of the sensing resources is inserted is 4 (subcarriers). The interval at which the code domain of the sensing resources is inserted may be referred to as a “code domain interval”.

### 1.6.4. Combination

The sensing resources may be separated from the communication resources in any combination of the time domain, the frequency domain, and the code domain. For example, the sensing resources may be separated from the communication resources in the frequency domain and/or the code domain within the same time domain. The sensing resources may be separated from the communication resources in the time domain and/or the code domain within the same frequency domain. Furthermore, the sensing resources may be separated from the communication resources in the time domain and/or the frequency domain within the same code domain. By any of the division multiplexing schemes described above, the sensing resources are separated from the communication resources.

1.7. Separation of Sensing Resources from Other Device

In addition to or instead of separation of the sensing resources from the communication resources described above, the sensing resources used for each sensing are separated within the time domain/frequency domain/code domain of the sensing resources. Owing to such separation, interference of the sensing signal between the devices can be avoided.

1.7.1. Frequency Division Multiplexing/Code Division Multiplexing within Same Time Domain

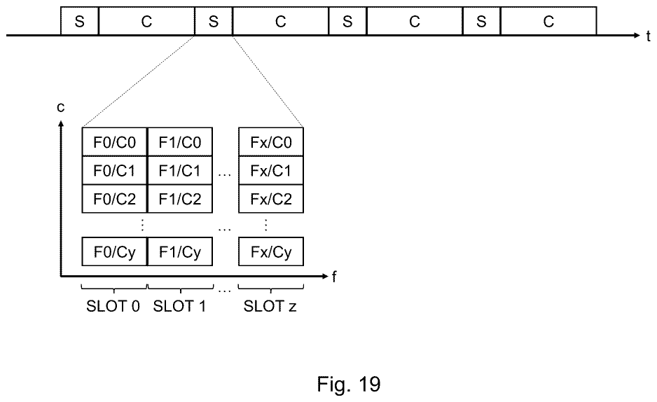

Within the time domain “S” of the sensing resources illustrated in FIG. 16, the sensing resources may be separated in the frequency domain and/or the code domain. As illustrated in FIG. 19, within the time domain indicated by slot 0, a different frequency domain, a different code domain, or a combination of a different frequency domain and a different code domain may be allocated. The same applies to subsequent slot 1 and slot z. In this manner, within the same time domain, the sensing resources are separated in the frequency domain and/or the code domain. Note that, in the present embodiment, the time domain is in units of slots, but may be in units of frames, subframes, or other time units, instead of slots.

1.7.2. Time Division Multiplexing/Code Division Multiplexing within Same Frequency Domain

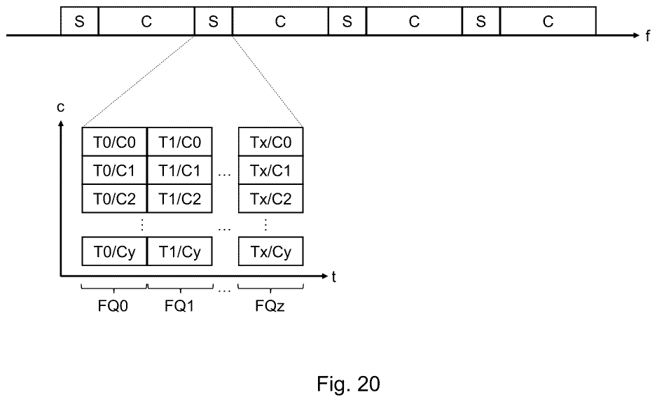

Within the frequency domain “S” of the sensing resources illustrated in FIG. 17, the sensing resources may be separated in the time domain and/or the code domain. As illustrated in FIG. 20, within the frequency domain representing a certain frequency band indicated by FQ0, a different time domain, a different code domain, or a combination of a different time domain and a different code domain may be allocated. The same applies to subsequent FQ1 and FQz. In this manner, within the same frequency domain, the sensing resources are separated in the time domain and/or the code domain.

1.7.3. Time Division Multiplexing/Frequency Division Multiplexing within Same Code Domain

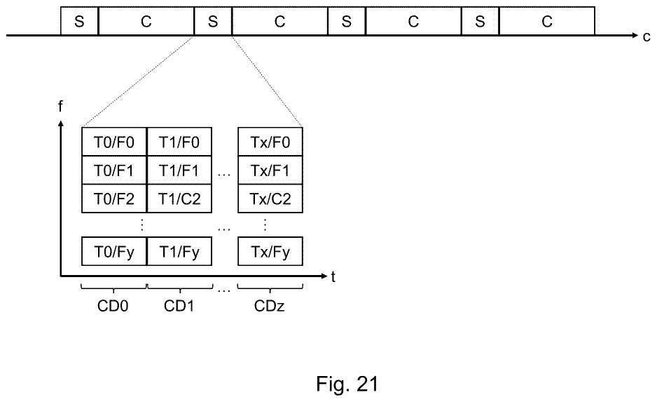

Within the code domain “S” of the sensing resources illustrated in FIG. 18, the sensing resources may be separated in the time domain and/or the frequency domain. As illustrated in FIG. 21, within the code domain indicated by CD0, a different time domain, a different frequency domain, or a combination of a different time domain and a different frequency domain may be allocated. The same applies to subsequent CD1 and CDz. In this manner, within the same code domain, the sensing resources are separated in the time domain and/or the frequency domain.

### 1.7.4. Assignment of Sensing ID

In order to identify resources, as described above, sensing IDs may be assigned to allocated resources. The sensing IDs are assigned to each of the resources allocated in any combination of the time domain, the frequency domain, and the code domain described above.

For example, when the sensing resources are separated in the time domain and the frequency domain in the method described above, the resources allocated for each sensing are resources allocated in a combination of a different slot and a different frequency. In the case, regarding the sensing IDs, the sensing IDs are allocated to each of the resources allocated in a combination of a different slot and a different frequency.

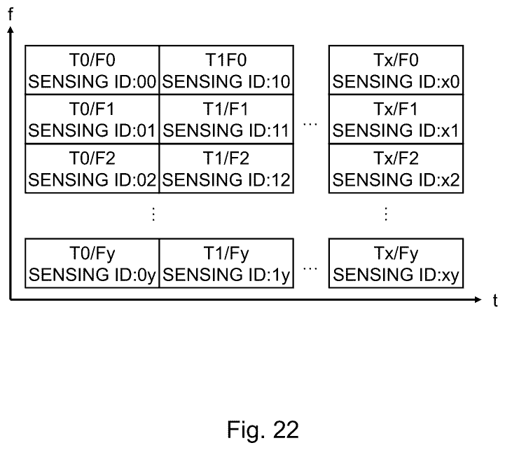

The sensing IDs are identifiers with which the allocated resources can be identified. For example, as illustrated in FIG. 22, consecutive numbers are assigned to each of the resources allocated in a combination of a different slot and a different frequency, and the sensing IDs correspond to the assigned consecutive numbers. Note that the sensing ID may be used exchangeably with a “resource ID” and a “sensing resource ID”.

When the resources allocated for each sensing are assigned the sensing IDs with which the resources can be identified in any combination of the time domain, the frequency domain, and the code domain, the resources used for performing sensing can be identified. For example, as will be described below, when the base station device 20 allocates the sensing resources, the terminal device 10 can identify the resources to be used by notifying the terminal device 10 of the sensing IDs.

In any of the methods described above, sensing is performed by using the allocated sensing resources. In sensing, the sensing transmitting device transmits a sensing signal, and the sensing receiving device receives the sensing signal.

In a procedure for allocating resources and a sensing start procedure, communication occurs between the terminal device 10 and the base station device 20 or between the terminal devices 10. The sensing start procedure may be performed using the sensing resources.

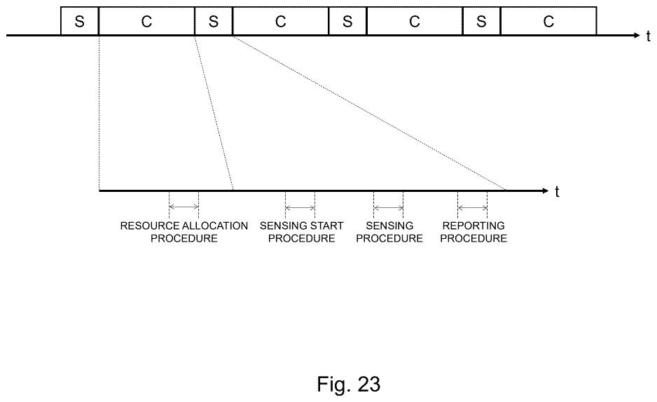

As illustrated in FIG. 23, both of the sensing start procedure and sensing may be performed within the time domain of the sensing resources. A procedure of reporting sensing results to be described below may also be performed within the time domain of the sensing resources. By using the sensing resources for the sensing start procedure, sensing can be more clearly separated from communication. Note that, although details will be described below, the procedure for allocating the sensing resources is referred to as a “resource allocation procedure”.

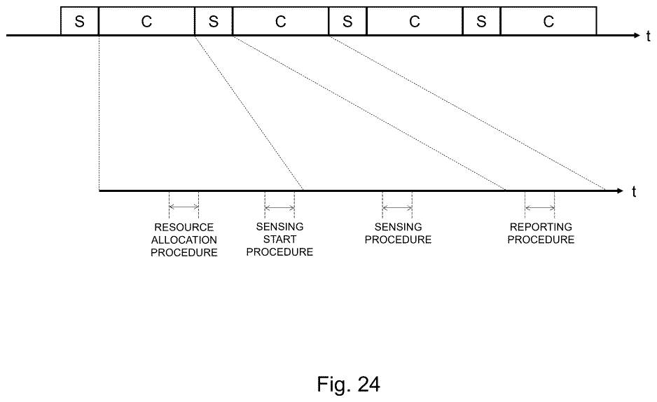

As illustrated in FIG. 24, the sensing start procedure may be performed within the time domain of the communication resources. The procedure of reporting sensing results to be described below may also be performed within the time domain of the communication resources. In this case, only sensing is performed by using the sensing resources, and therefore the allocation amount of the sensing resources can be reduced as compared to the communication resources.

### 1.8. Resource Allocation Procedure

### 1.8.1. Resource Allocation Performed by Base Station Device

While the sensing resources are allocated as described above, the resource allocation procedure is performed with various methods. In the resource allocation procedure, the base station device 20 may allocate the sensing resources to the terminal device 10.

### (1) Scheduling Request (SR)

The base station device 20 may allocate the sensing resources in response to a request for sensing resource allocation from the terminal device 10. For the request, for example, an SR used to request PUSCH radio resource allocation may be used.

The base station device 20 allocates PUCCH resources for transmitting the SR to the terminal device 10. The base station device 20 transmits an RRC message including a parameter of the SR to the terminal device 10. The parameter of the SR is included in a SchedulingRequestResourceConfig IE as an example of an information element (IE) of RRC.

The terminal device 10 transmits UCI including the SR to the base station device 20 by using the configured PUCCH resources. The terminal device 10 may transmit the UCI on demand. The terminal device 10 may transmit the UCI with configured periodicity. For example, the terminal device 10 may transmit the SR (negative SR) set to “0” and/or the SR (positive SR) set to “1”. The base station device 20 allocates the sensing resources to the terminal device 10 according to the SR.

### (2) Dynamic Grant (DG)

A DG is a scheduling method for allocating PUSCH radio resources according to a procedure of an uplink grant. The sensing resources may be allocated by using the scheduling method. The base station device 20 transmits a grant to the terminal device 10 on the PDCCH. The terminal device 10 performs sensing according to the grant. For example, the base station device 20 may allocate the sensing resources by using a DCI format (i.e., a DCI format used to allocate the sensing resources) with a CRC scrambled with a C-RNTI and/or an MCS-C-RNTI, and the terminal device 10 may perform sensing by using the allocated sensing resources. Here, a new data indicator included in the DCI format to which the CRC scrambled with the C-RNTI and/or the MCS-C-RNTI is added may be set to 0 or 1.

The base station device 20 may allocate the sensing resources by using a DCI format (i.e., a DCI format used to allocate the sensing resources) with a CRC scrambled with a CS-RNTI, and the terminal device 10 may perform sensing by using the allocated sensing resources. Here, a new data indicator included in the DCI format with the CRC scrambled with the CS-RNTI may be set to 1.

### (3) Semi-Persistent Scheduling (SPS)

SPS is a scheduling method for semi-persistently allocating PUSCH radio resources by using the DCI format described above. The sensing resources may be allocated by using the scheduling method. “Semi-persistent” may be used exchangeably with “periodic”. With the scheduling method, the terminal device 10 is allocated with the sensing resources with configured periodicity.

### (4) Configured Grant (CG)

A CG is a scheduling method for allocating PUSCH radio resources without the procedure of the dynamic grant described above. The sensing resources may be allocated by using the scheduling method. The CG includes two types of type 1 and type 2, and the sensing resources may be allocated with a method similar to CG type 1.

In the method similar to CG type 1, the base station device 20 transmits an RRC message including a parameter of the CG to the terminal device 10. The parameter of the CG is included in a ConfiguredGrantConfig IE as an example of an information element (IE) of RRC. The ConfiguredGrantConfig IE includes information for identifying the time domain/frequency domain/code domain of the sensing resources, such as the interval at which the time domain of the sensing resources is inserted described above, for example. The terminal device 10 performs sensing by using the allocated sensing resources without a trigger using the DCI.

The sensing resources may be allocated with a method similar to CG type 2. In the method similar to CG type 2, the base station device 20 transmits DCI scrambled with a CS-RNTI to the terminal device 10. The CS-RNTI is used to activate (activation) periodic transmission. The terminal device 10 performs sensing by using the allocated sensing resources in response to the activation by the DCI scrambled with the CS-RNTI.

In any of the methods described above, when the base station device 20 allocates the sensing resources, the sensing ID is assigned. The sensing ID may be transmitted to the terminal device 10. The sensing ID may be transmitted using an RRC message or a message of another layer such as a MAC CE, for example.

1.8.2. Resource Determination with RNTI

Instead of the resource allocation method described above, for example, the base station device 20 may allocate the sensing resources in advance, and associate the sensing ID for the allocated resources with an RNTI. Information of association with the sensing ID and the RNTI may be transmitted to the terminal device 10 as broadcast information, for example. In this manner, the terminal device 10 can identify the assigned sensing ID and then the allocated resources by using the RNTI assigned to the terminal device 10 itself.

For example, a predetermined arithmetic operation may be performed based on the RNTI, and the sensing ID may be calculated by using a numerical value calculated as a result of the arithmetic operation.

Furthermore, the sensing ID may be calculated as follows.
Sensing ID=RNTI mod x, or
Sensing ID=RNTI mod x+y
x and y are each a predetermined integer.

### 1.8.3. Selection Performed by Terminal Device

Instead of the resource allocation method described above, for example, the base station device 20 may allocate the sensing resources in advance, and transmit a list including multiple sensing IDs corresponding to the allocated resources to the terminal device 10 as broadcast information, for example. In this manner, by selecting the sensing ID from the list, the terminal device 10 can secure the sensing resources to be used by the terminal device 10 itself.

### 1.9. Sensing Procedure

In the resource allocation procedure described above, the sensing resources are allocated, and the sensing ID is assigned. Subsequently, the base station device 20 and/or the terminal device 10 performs a sensing procedure. The sensing procedure includes the above-described sensing start procedure, sensing, and the procedure of reporting sensing results in a case of cooperative-sensing. The procedure of reporting sensing results is hereinafter referred to as a “reporting procedure”.

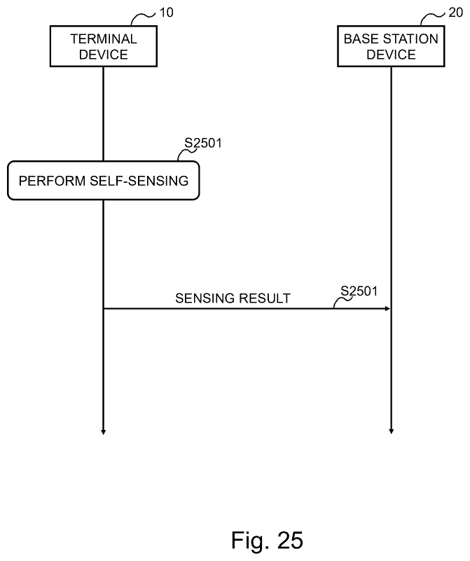

Processing performed by the terminal device 10 to be described with reference to FIG. 25 to FIG. 29 below is performed by the controller 110 and the transmitter 121 and the receiver 122 of the communicator 120. Processing performed by the base station device 20 is performed by the controller 210 and the transmitter 221 and the receiver 222 of the communicator 220.

### 1.9.1. Self-Sensing

### (1) Self-Sensing Performed by Terminal Device

With reference to FIG. 25, a procedure in which the terminal device 10 performs self-sensing will be described. The terminal device 10 is assigned the sensing ID in the resource allocation procedure. The terminal device 10 reports sensing results to the base station device 20.

In Step S2501, the terminal device 10 performs self-sensing. Self-sensing is performed by transmitting a sensing signal by using allocated resources, receiving the sensing signal reflected from a detection target, and analyzing a change in a frequency spectrum of the received signal.

In Step S2502, the terminal device 10 transmits sensing results to the base station device 20. The sensing results may be transmitted using an RRC message or a message of another layer such as a MAC CE, for example. In this manner, the sensing procedure including self-sensing is performed.

(2) Self-Sensing in Response to Request from Terminal Device

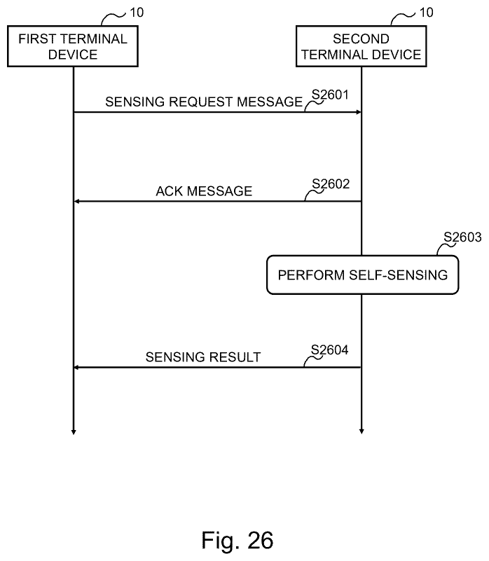

With reference to FIG. 26, a procedure in which the first terminal device 10 requests the second terminal device 10 to perform self-sensing and the second terminal device 10 performs self-sensing will be described. The first terminal device 10 is assigned the sensing ID in the resource allocation procedure. The second terminal device 10 reports sensing results to the first terminal device 10.

In Step S2601, as the sensing initiator, the first terminal device 10 transmits a sensing request message to the second terminal device 10. The sensing request message includes the sensing ID. The sensing request message may be transmitted via a PC5 interface, for example. In Step S2602, as the sensing responder, the second terminal device 10 transmits an ACK message to the first terminal device 10. The ACK message may be transmitted via the PC5 interface, for example.

In Step S2603, the second terminal device 10 identifies the sensing resources corresponding to the sensing ID included in the sensing request message, and performs self-sensing by using the identified sensing resources.

In Step S2604, the second terminal device 10 transmits sensing results to the first terminal device 10. The sensing results may be transmitted via the PC5 interface, for example. In this manner, the sensing procedure including self-sensing is performed.

Note that, in the example illustrated in FIG. 26, the first terminal device 10 serves as the sensing initiator, but the base station device 20 may serve as the sensing initiator. In this case, the second terminal device 10 performs self-sensing in response to the sensing request message from the base station device 20.

### 1.9.2. Cooperative-Sensing

(1) Cooperative-Sensing with Sensing Initiator as Sensing Transmitting Device

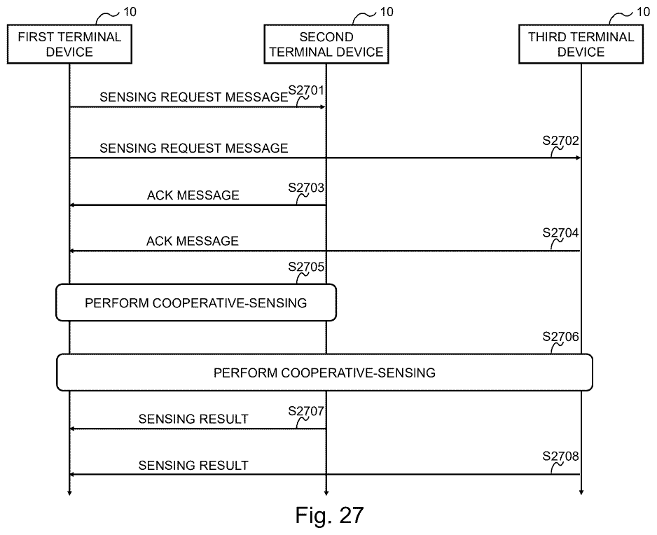

With reference to FIG. 27, a procedure in which the first terminal device 10 requests the second terminal device 10 and the third terminal device 10 to perform cooperative-sensing and the first terminal device 10, the second terminal device 10, and the third terminal device 10 perform cooperative-sensing will be described. In the example illustrated in FIG. 27, the first terminal device 10 serves as the sensing transmitting device, and the second terminal device 10 and the third terminal device 10 serve as the sensing receiving devices. The first terminal device 10 is assigned the sensing ID in the resource allocation procedure. The second terminal device 10 and the third terminal device 10 report sensing results to the first terminal device 10.

In Step S2701, as the sensing initiator, the first terminal device 10 transmits a sensing request message to the second terminal device 10. Similarly, in Step S2702 as well, as the sensing initiator, the first terminal device 10 transmits a sensing request message to the third terminal device 10. The sensing request message includes the sensing ID. The sensing request message may be transmitted via a PC5 interface, for example.

In Step S2703, as the sensing responder, the second terminal device 10 transmits an ACK message to the first terminal device 10. Similarly, in Step 2704 as well, as the sensing responder, the third terminal device 10 transmits an ACK message to the first terminal device 10. The ACK message may be transmitted via the PC5 interface, for example.

In Step S2705, the first terminal device 10 and the second terminal device 10 perform cooperative-sensing. Similarly, in Step 2706 as well, the first terminal device 10 and the third terminal device 10 perform cooperative-sensing. In cooperative-sensing performed by the first terminal device 10 and the second terminal device 10, the first terminal device 10 transmits a sensing signal by using the sensing resources corresponding to the sensing ID. The second terminal device 10 identifies the sensing resources from the sensing ID included in the sensing request message, and receives the sensing signal by using the identified sensing resources. The same applies to cooperative-sensing performed by the first terminal device 10 and the second terminal device 10.

In Step S2707, the second terminal device 10 transmits sensing results to the first terminal device 10. Similarly, in Step S2708 as well, the third terminal device 10 transmits sensing results to the first terminal device 10. The sensing results may be transmitted via the PC5 interface, for example. In this manner, the sensing procedure including cooperative-sensing is performed.

Note that, in the example illustrated in FIG. 27, the first terminal device 10 serves as the sensing initiator, but the base station device 20 may serve as the sensing initiator. In this case, the first terminal device 10, the second terminal device 10, and the third terminal device 10 perform cooperative-sensing in response to the sensing request message from the base station device 20. The base station device 20 may serve as the sensing transmitting device. In this case, cooperative-sensing is performed by the base station device 20 transmitting a sensing signal to the second terminal device 10 and the third terminal device 10 and the second terminal device 10 and the third terminal device 10 each receiving the sensing signal.

(2) Cooperative-Sensing with Sensing Initiator as Sensing Receiving Device

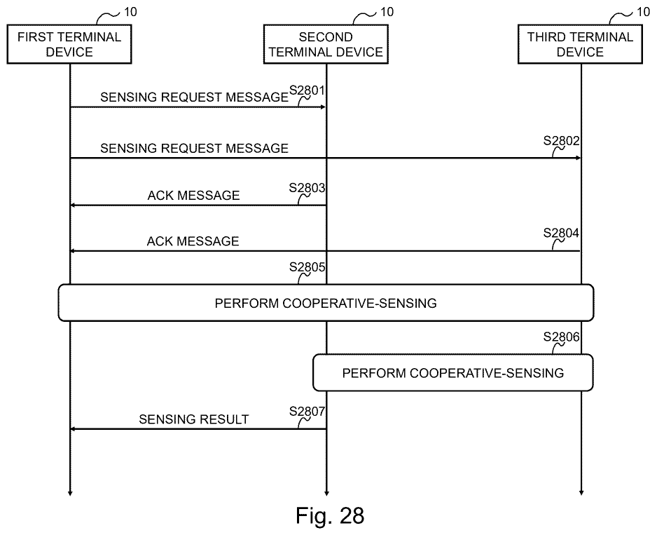

With reference to FIG. 28, a procedure in which the first terminal device 10 requests the second terminal device 10 and the third terminal device 10 to perform cooperative-sensing and the first terminal device 10, the second terminal device 10, and the third terminal device 10 perform cooperative-sensing will be described. In the example illustrated in FIG. 28, the first terminal device 10 and the second terminal device 10 serve as the sensing receiving devices, and the third terminal device 10 serves as the sensing transmitting device. The first terminal device 10 is assigned the sensing ID in the resource allocation procedure. The second terminal device 10 reports sensing results to the first terminal device 10.

In Step S2801, as the sensing initiator, the first terminal device 10 transmits a sensing request message to the second terminal device 10. Similarly, in Step 2802 as well, as the sensing initiator, the first terminal device 10 transmits a sensing request message to the third terminal device 10. The sensing request message includes the sensing ID. The sensing request message may be transmitted via a PC5 interface, for example.

In Step S2803, as the sensing responder, the second terminal device 10 transmits an ACK message to the first terminal device 10. Similarly, in Step 2804 as well, as the sensing responder, the third terminal device 10 transmits an ACK message to the first terminal device 10. The ACK message may be transmitted via the PC5 interface, for example.

In Step S2805, the first terminal device 10 and the third terminal device 10 perform cooperative-sensing. Similarly, in Step 2806 as well, the second terminal device 10 and the third terminal device 10 perform cooperative-sensing. In cooperative-sensing performed by the first terminal device 10 and the third terminal device 10, the third terminal device 10 identifies the sensing resources from the sensing ID included in the sensing request message, and transmits a sensing signal by using the identified sensing resources. The first terminal device 10 receives the sensing signal by using the sensing resources corresponding to the sensing ID. The same applies to cooperative-sensing performed by the second terminal device 10 and the third terminal device 10.

In Step S2807, the second terminal device 10 transmits sensing results to the first terminal device 10. The sensing results may be transmitted via the PC5 interface, for example. In this manner, the sensing procedure including cooperative-sensing is performed.

Note that, in the example illustrated in FIG. 28, the first terminal device 10 serves as the sensing initiator, but the base station device 20 may serve as the sensing initiator. In this case, the first terminal device 10, the second terminal device 10, and the third terminal device 10 perform cooperative-sensing in response to the sensing request message from the base station device 20.

The first embodiment has been described as in the above. According to the first embodiment, the resources are allocated in any combination of the time domain, the frequency domain, and the code domain for each sensing, and therefore interference of the sensing signal between the devices can be prevented. The sensing resources are separated from the communication resources, and therefore interference between the sensing signal and the communication signal can be prevented.

### 2. SECOND EMBODIMENT

### 2.1. Insertion of Non-Transmission Period

As described above, when sensing is performed, the sensing transmitting device transmits a sensing signal, and the sensing receiving device receives the sensing signal transmitted from the sensing transmitting device. This means that performing sensing requires time from when the sensing transmitting device transmits a sensing signal until the sensing signal arrives at the sensing receiving device. In a second embodiment, the sensing resources are allocated also in consideration of the time until the sensing signal arrives at the sensing receiving device in the time domain of the sensing resources.

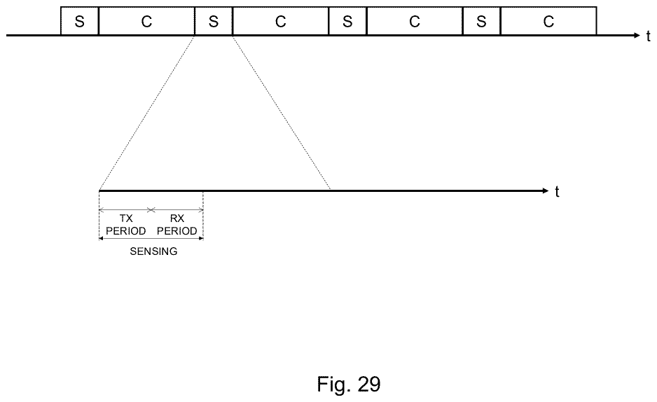

As illustrated in FIG. 29, in consideration of the time for the sensing receiving device to receive the sensing signal, the allocated sensing resources may be allocated with time including not only a transmission period (TX period) for transmitting the sensing signal but also a reception period in the time domain. The reception period (RX period) may be used exchangeably with a “non-transmission period (NTX period)”.

2.2. Generation of Signal Waveform with Insertion of Non-Transmission Period

For example, when the sensing signal is transmitted with the transmission scheme of DFTS-OFDM, the sensing signal including the transmission period and the non-transmission period may be generated as follows.

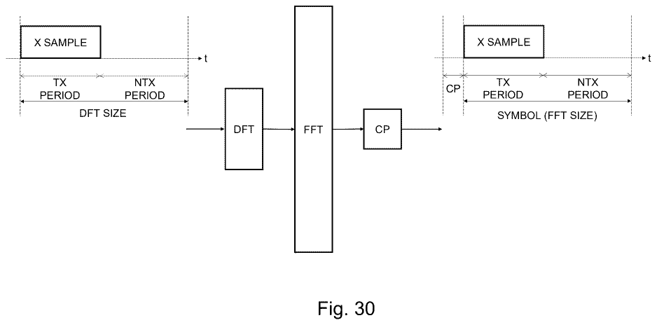

As illustrated in FIG. 30, first, for the sensing signal, a length corresponding to a sample length of X is allocated as the transmission period in the time domain. Then, a length obtained by adding the non-transmission period to the transmission period is allocated as a DFT size. The non-transmission period is a period without a signal.

Then, DFT and FFT are performed, and a CP is added. The CP may be added as the non-transmission period. In the signal converted as described above, a length corresponding to the sample length of X is allocated as the transmission period. Then, a length obtained by adding the non-transmission period to the transmission period is allocated as a symbol length or an FFT size.

In this manner, the sensing resources can be allocated also in consideration of the time until the sensing signal arrives at the sensing receiving device in the time domain.

The transmission period is allocated corresponding to the length corresponding to the sample length of X, and therefore the length of the transmission period can be appropriately configured in accordance with the sample length. The FFT size is obtained by allocating the length obtained by adding the non-transmission period to the transmission period as the DFT size and then performing FFT, and therefore the length obtained by adding the non-transmission period to the transmission period can be appropriately configured in accordance with the FFT size.

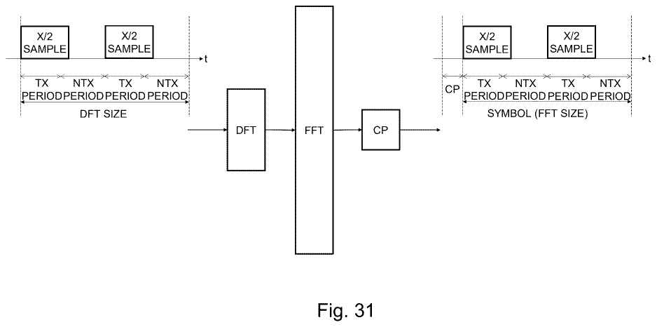

Multiple transmission periods may be allocated. For example, as illustrated in FIG. 31, a first transmission period, a first non-transmission period, a second transmission period, and a second non-transmission period may be allocated as the DFT size. In the example illustrated in FIG. 31, the first transmission period and the second transmission period correspond to a sample length of X/2 of the sample length of X illustrated in FIG. 30. The first non-transmission period and the second non-transmission period correspond to ½ of the non-transmission period illustrated in FIG. 30.

By allocating the transmission periods and the non-transmission periods as described above, performing DFT and FFT, and adding a CP, the first transmission period, the first non-transmission period, the second transmission period, and the second non-transmission period are allocated as the FFT size.

When the terminal device 10 transmits the sensing signal, the processing of generating a signal waveform described with reference to FIG. 30 and FIG. 31 above is performed by the controller 110 in the terminal device 10 and the transmitter 121 and the receiver 122 of the communicator 120. When the base station device 20 transmits the sensing signal, the processing is performed by the controller 210 and the transmitter 221 and the receiver 222 of the communicator 220.

The second embodiment has been described as in the above. According to the second embodiment, the non-transmission period is also allocated in addition to the transmission period in the time domain of the sensing resources, and therefore the resources can be more appropriately allocated to transmit the sensing signal.

### 3. THIRD EMBODIMENT

The first embodiment has described an example of separating the sensing resources from the communication resources in any combination of the time domain, the frequency domain, and the code domain. When more sensing resources are allocated in separating the sensing resources from the communication resources, it is expected that accuracy of sensing is enhanced but a communication speed decreases. Conversely, when fewer sensing resources are allocated, it is expected that the communication speed increases but accuracy of sensing decreases.

In a third embodiment, a ratio between allocated communication resources and allocated sensing resources is made variable. The following will describe an example in which the ratio between the allocated communication resources and the allocated sensing resources is made variable on the assumption that the sensing resources are separated from the communication resources in the time domain.

For example, by reducing a value of the time domain periodicity being the interval at which the time domain of the sensing resources is inserted with respect to the communication resources described above, more sensing resources can be allocated in the time domain.

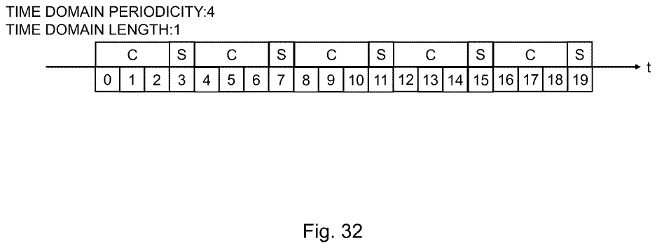

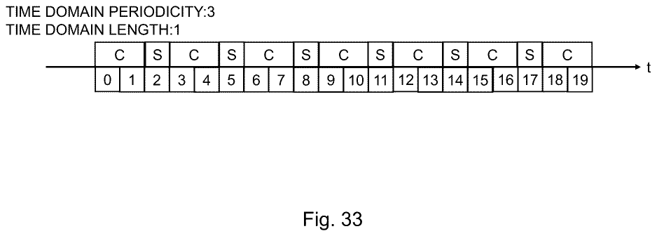

FIG. 32 illustrates an example in which there are 20 slots in one frame and the time domain having a one-slot length of the sensing resources is inserted every four slots within one frame. In this case, the time domain periodicity is 4. For example, by changing the value of the time domain periodicity to 3, as illustrated in FIG. 33, the time domain having a one-slot length of the sensing resources is inserted every three slots within one frame, and more sensing resources can be allocated.

For example, by increasing a value of the time domain length being a length of the time domain of the sensing resources described above, more sensing resources can be allocated in the time domain.

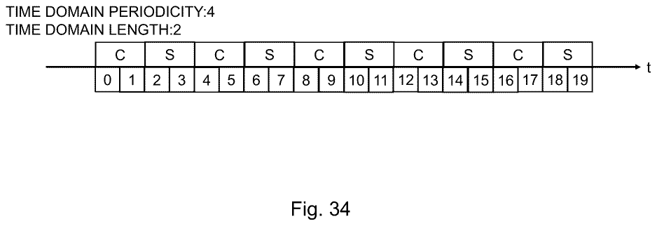

As described above, the example illustrated in FIG. 32 illustrates an example in which there are 20 slots in one frame and the time domain having a one-slot length of the sensing resources is inserted every four slots within one frame. For example, by changing the value of the time domain length to 2, as illustrated in FIG. 34, the time domain of the sensing resources having a two-slot length is inserted every four slots within one frame, and more sensing resources can be allocated.

As described above, by changing the time domain periodicity and/or the time domain length in the time domain, the ratio between the allocated communication resources and the allocated sensing resources can be made variable. In the frequency domain, by changing the frequency domain interval being the interval at which the frequency domain of the sensing resources is inserted, the ratio between the allocated communication resources and the allocated sensing resources can be made variable. In the code domain, by changing the code domain interval being the interval at which the code domain of the sensing resources is inserted, the ratio between the allocated communication resources and the allocated sensing resources can be made variable.

The parameters described above may be changed by the base station device 20 according to communication traffic, priority between sensing and communication, a request from the terminal device 10 or the number of the requests, and the like, for example. In other words, the ratio between the allocated communication resources and the allocated sensing resources changes according to predetermined conditions. The changed parameters may be notified from the base station device 20 to the terminal device 10, from the terminal device 10 to the base station device 20, or between the terminal devices 10.

The third embodiment has been described as in the above. According to the third embodiment, the communication resources and the sensing resources can be appropriately allocated according to conditions such as communication traffic.

### 4. FOURTH EMBODIMENT

As described above, sensing is performed by transmitting a sensing signal to a detection target, receiving the sensing signal reflected from the detection target, and analyzing a change in a frequency spectrum of the received signal. For example, when a moving detection target is detected, by repeating sensing multiple times and changing a beam of the sensing signal for each sensing (beam sweeping), the moving detection target can be detected with high accuracy.

In a fourth embodiment, sensing is repeated multiple times. The following will describe an example in which interference of the sensing signal between the devices is prevented when sensing is performed multiple times.

### 4.1. Change of Beams, Frequencies, and Signal Sequences

For example, sensing is consecutively performed n times within a predetermined period. In the present embodiment, in each sensing performed multiple times, it is performed by changing beams, frequencies, and code/signal sequences. The code/signal sequence is hereinafter collectively referred to as a “signal sequence”.

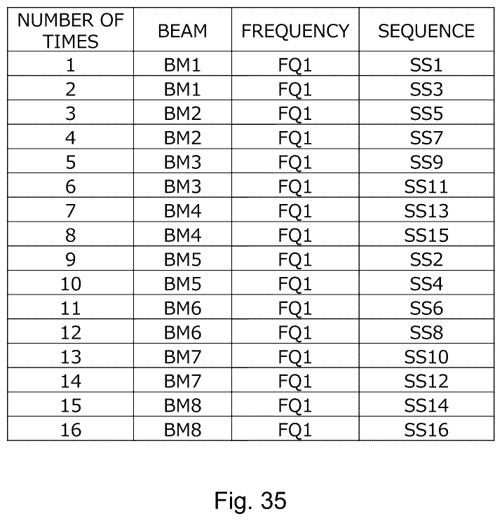

FIG. 35 illustrates an example in which the beams and the signal sequences are changed in each sensing when sensing is consecutively performed 16 times. As illustrated in FIG. 35, among 16 times of sensing, the same beam is consecutively applied two times, and a different beam is applied in the following two times of sensing. In other words, the beams are changed every two times. In all the 16 times of sensing, the same frequency is applied. Furthermore, in all the 16 times of sensing, different signal sequences are applied. Note that a different beam includes a case in which a direction, intensity, a pattern, and the like of a beam are different.

In the example illustrated in FIG. 35, throughout the sensing, sequence hopping, in which the signal sequences are randomly changed, is performed. In the example illustrated in FIG. 35, sensing is performed two times each by applying the same frequency and different sequences and changing the beams every two times. In this manner, the detection target can be more accurately detected by using Doppler estimation. Note that changing the beams every two times is merely an example. For example, the beams may be changed every m times, where m represents the number of times being two or more times.

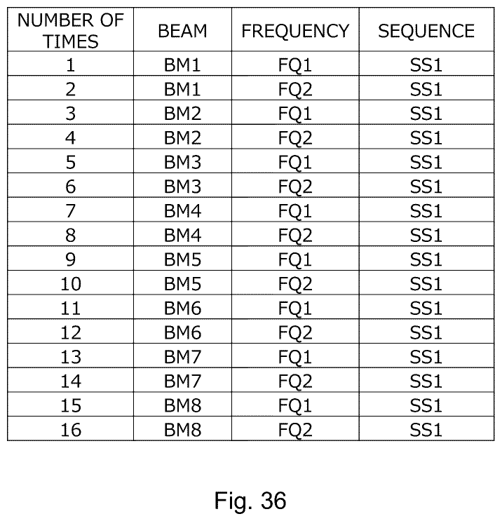

FIG. 36 illustrates an example in which the beams and the frequencies are changed in each sensing when sensing is consecutively performed 16 times. As illustrated in FIG. 36, among 16 times of sensing, the beams are changed every two times. Among two times of sensing, a first frequency is applied in first sensing and a second frequency is applied in second sensing, and this is repeated two times each. In other words, the first frequency and the second frequency are alternately applied in two times of sensing. Furthermore, in all the 16 times of sensing, the same signal sequence is applied.

In the example illustrated in FIG. 36, sensing is performed two times each by applying the same signal sequence and different frequencies and changing the beams every two times. In this manner, an effect of frequency diversity can be obtained. Note that changing the beams every two times and alternately applying the first frequency and the second frequency is merely an example. For example, the beams may be changed every m times, where m represents the number of times being two or more times, and the first frequency to an m-th frequency may be alternately applied in m times of sensing.

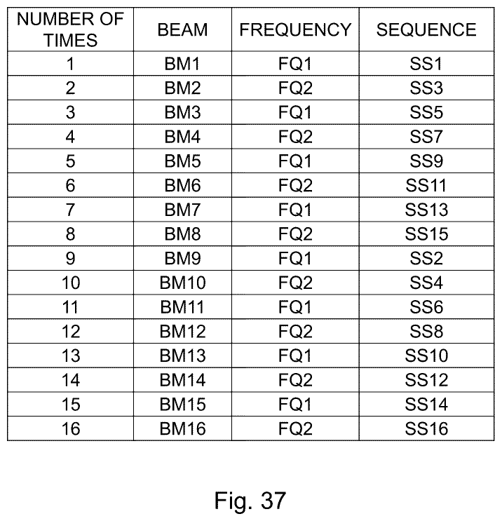

FIG. 37 illustrates an example in which the beams, the frequencies, and the signal sequences are changed in each sensing when sensing is consecutively performed 16 times. As illustrated in FIG. 37, in all the 16 times of sensing, different beams and different signal sequences are applied. The first frequency is applied in the first sensing and the second frequency is applied in the second sensing, and this is repeated two times each. In other words, the first frequency and the second frequency are alternately applied in two times of sensing.

In the example illustrated in FIG. 37, throughout the sensing, sequence hopping, in which the signal sequences are randomly changed, is performed. In the example illustrated in FIG. 37, different beams are applied throughout the sensing. In this manner, a large number of beams can be supported. Note that alternately applying the first frequency and the second frequency is merely an example. For example, the first frequency to the m-th frequency may be alternately applied in m times of sensing, where m is an integer of 2 or greater.

Changing the beams, the frequencies, and the signal sequences in each sensing illustrated in FIG. 35 to FIG. 37 is merely an example. In the present embodiment, one or a combination of the beam, the frequency, and the signal sequence is changed in each sensing. In this manner, when sensing is performed multiple times, interference of the sensing signal between the devices is prevented, and accuracy of sensing can be enhanced.

### 4.2. Resource Allocation

The sensing resources used for sensing are allocated in the resource allocation procedure described above. In other words, the sensing resources are allocated by the base station device 20, determined by an RNTI, or selected by the terminal device 10. In any of the cases, when sensing is performed n times, the resource allocation procedure may be performed in performing sensing of each of the n times.

The sensing resources for n times may be allocated by performing the resource allocation procedure once. In this case, by performing the resource allocation procedure once, n sensing IDs are allocated. For example, when the terminal device 10 requests the base station device 20 to perform resource allocation, the number of times of sensing to be performed may be notified. The number of times of sensing to be performed is hereinafter referred to as the “number of times of sensing”. According to the notified number of times of sensing, the base station device 20 allocates the sensing resources corresponding to the number of times of sensing, and assigns corresponding sensing IDs.

For example, in the method of calculating the sensing ID based on the RNTI described above, when a-th sensing out of n times is performed, the sensing ID may be calculated as follows.
Sensing ID=RNTI mod x+a
x is a predetermined integer.

The allocated sensing IDs may be n independent sensing IDs. The allocated sensing IDs may be n related sensing IDs. In this case, for example, each of the n sensing IDs may have a branch number different from a common number. The common number corresponds to a common sensing ID, and the branch number corresponds to a sub-sensing ID.

### 4.3. Notification in Cooperative-Sensing

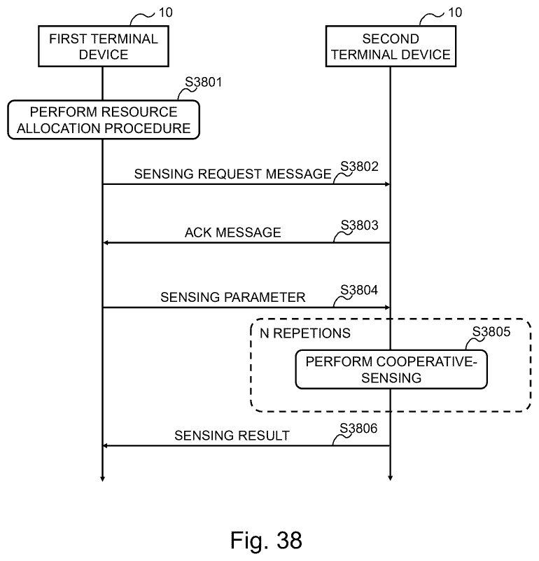

When sensing is consecutively performed multiple times, in cooperative-sensing, for example, the sensing initiator needs to notify the sensing responder of information such as the number of times of sensing. With reference to FIG. 38, a sensing procedure in which the first terminal device 10 and the second terminal device 10 perform cooperative-sensing n times will be described. In the example illustrated in FIG. 38, the first terminal device 10 serves as the sensing transmitting device, and the second terminal device 10 serves as the sensing receiving device. The first terminal device 10 serves as the sensing initiator, and the second terminal device 10 serves as the sensing responder.

In Step S3801, the first terminal device 10 performs the resource allocation procedure, and allocates the sensing resources corresponding to the number n of times of sensing. Through the procedure, n sensing IDs are assigned.

In Step S3802, as the sensing initiator, the first terminal device 10 transmits a sensing request message to the second terminal device 10. The sensing request message includes the sensing ID. The sensing request message may be transmitted via a PC5 interface, for example.

Regarding the sensing IDs, in Step S3802, the sensing IDs corresponding to n times of sensing may be collectively notified from the first terminal device 10 to the second terminal device 10. Instead, in Step S3805, each time sensing is performed, the sensing ID for subsequent sensing may be notified from the first terminal device 10 to the second terminal device 10.

In Step S3803, as the sensing responder, the second terminal device 10 transmits an ACK message to the first terminal device 10. The ACK message may be transmitted via the PC5 interface, for example.

In Step S3804, the first terminal device 10 notifies the second terminal device 10 of parameters related to sensing. The parameters related to sensing are hereinafter referred to as “sensing parameters”. The sensing parameters may be transmitted via the PC5 interface, for example.

The sensing parameters include the number of times of sensing. The sensing parameters include patterns as illustrated in FIG. 35 to FIG. 37. The patterns indicate how to change any of the beam, the frequency, and the code/signal sequence in each of sensing performed n times. Such patterns are hereinafter referred to as “sensing patterns”.

In addition to the above, the sensing parameters may include the following information.
Transmission period inserted in the sensing resource time domain
Transmission period+non-transmission period inserted in the sensing resource time domain
Frequency bandwidth applied in each sensing
Signal sequence number applied in each sensing

The information included in the sensing parameters described above, such as the transmission period and the frequency bandwidth, needs to be notified in each sensing. Regarding the information, in Step S3803, the information corresponding to n times of sensing may be collectively notified from the first terminal device 10 to the second terminal device 10. Instead, in Step S3805, each time sensing is performed, the information for subsequent sensing may be notified from the first terminal device 10 to the second terminal device 10.

In Step S3805, the first terminal device 10 and the second terminal device 10 repeatedly perform n times of cooperative-sensing.

In Step S3806, the second terminal device 10 transmits sensing results to the first terminal device 10. The sensing results may be transmitted via the PC5 interface, for example.

Regarding the sensing results, in Step S3805, the sensing results corresponding to n times of sensing may be collectively transmitted from the second terminal device 10 to the first terminal device 10. Instead, in Step S3805, each time sensing is performed, the sensing results for subsequent sensing may be notified from the first terminal device 10 to the second terminal device 10.

In the procedure illustrated in FIG. 38, the resource allocation procedure, notification of the resource ID, notification of the sensing parameters, and the reporting procedure are collectively performed, corresponding to n times of sensing. Instead, each time sensing is performed, the procedures may be individually performed.

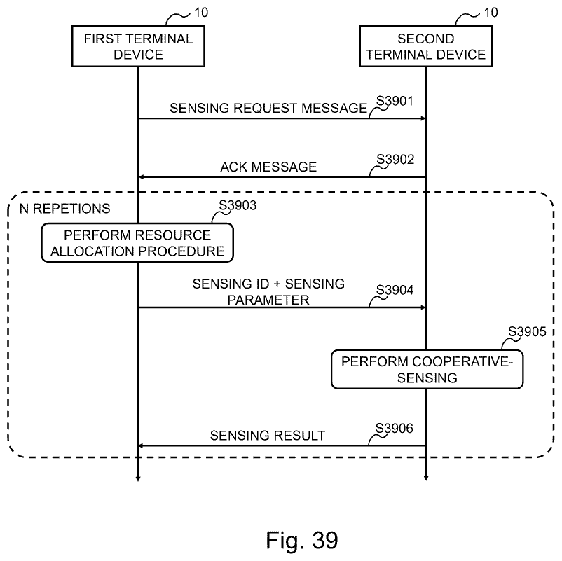

With reference to FIG. 39, another sensing procedure in which the first terminal device 10 and the second terminal device 10 perform cooperative-sensing n times will be described. In the example illustrated in FIG. 39 as well, the first terminal device 10 serves as the sensing transmitting device, and the second terminal device 10 serves as the sensing receiving device. The first terminal device 10 serves as the sensing initiator, and the second terminal device 10 serves as the sensing responder.

In Step S3901, as the sensing initiator, the first terminal device 10 transmits a sensing request message to the second terminal device 10. In Step S3902, as the sensing responder, the second terminal device 10 transmits an ACK message to the first terminal device 10.

In Step S3903, in order to allocate the resources for performing the a-th sensing out of n times, the first terminal device 10 performs the resource allocation procedure, and allocates the sensing resources for the a-th sensing. Through the procedure, a corresponding sensing ID is assigned.

In Step S3904, the first terminal device 10 notifies the second terminal device 10 of the sensing ID used for the a-th sensing. The first terminal device 10 notifies the second terminal device 10 of the sensing parameters. The sensing parameters include one of the transmission period, the transmission period+the non-transmission period, the frequency bandwidth, the signal sequence number, and the like applied in the a-th sensing.

In Step S3905, the first terminal device 10 and the second terminal device 10 repeatedly perform n times of cooperative-sensing. In Step S3906, the second terminal device 10 transmits sensing results to the first terminal device 10.

Step S3903 to Step S3906 are repeated n times. In this manner, the resource allocation procedure, notification of the resource ID, notification of the sensing parameters, and the reporting procedure are individually performed, corresponding to n times of sensing.

In the example illustrated in FIG. 39, after Step S3906 is performed in the a-th sensing, Step S3903 to Step S3906 are performed in subsequent (a+1)-th sensing. After Step S3906, the first terminal device 10 and the second terminal device 10 may perform notification that the (a+1)-th sensing is performed after the a-th sensing. In n-th sensing as the last sensing out of n times, after Step S3906, the first terminal device 10 and the second terminal device 10 may perform notification that sensing ends.

In the example illustrated in FIG. 39, instead of performing notification of the number of times of sensing at the beginning, each time sensing is performed, the first terminal device 10 and the second terminal device 10 perform notification of information related to subsequent sensing.

Note that, in the examples illustrated in FIG. 38 and FIG. 39, the first terminal device 10 serves as the sensing transmitting device and the sensing initiator, but the base station device 20 may serve as the sensing transmitting device and the sensing initiator. In this case, the base station device 20 and the first terminal device 10 and/or the second terminal device 10 perform cooperative-sensing in response to the sensing request message from the base station device 20. In FIG. 38 and FIG. 39, the processing of the sensing procedure is performed by the controller 110 in the terminal device 10 and the transmitter 121 and the receiver 122 of the communicator 120. When the base station device 20 performs cooperative-sensing, the processing is performed by the controller 210 and the transmitter 221 and the receiver 222 of the communicator 220.

### 5. ALTERATIONS

While the present disclosure has been described with reference to the embodiments, it is to be understood that the present disclosure is not limited to the embodiments and structures. The present disclosure includes various alterations and alterations within the scope of equivalents. Other combinations including one or more elements included in the embodiments are also within the scope and the concept of the present disclosure.

Expressions such as words and phrases used in the embodiments are merely examples, and may be replaced with substantially the same or similar expressions. Particularly, since the technique according to the embodiments relates to technical specifications, the expressions in the embodiments may be replaced with substantially the same or similar expressions in the technical specifications (for example, the technical specifications cited in the Specification of the present application).

The information transmitted/received in the embodiments may be transmitted/received in the same or a different message or the same or a different element as or from that already described in the technical specifications, or may be transmitted/received in a new message or element to be defined. The information transmitted/received in the embodiments may be transmitted/received using a different layer and/or a different channel from that of the embodiments.

The means and/or the functions provided by the devices described in the embodiments can be provided by software stored in a tangible memory device and a computer that executes the software, the software only, hardware only, or a combination of those. For example, when one of the devices is provided by an electronic circuit being hardware, it can be provided by a digital circuit including a number of logic circuits or an analog circuit.

The devices described in the embodiments execute a program stored in a non-transitory tangible storage medium. Execution of the program causes execution of a method corresponding to the program.

### 6. SUPPLEMENTARY NOTES

The whole or part of the embodiments and the alterations can be described as the following supplementary notes, but the disclosure is not limited to the contents of the following supplementary notes. The following expresses relationships in which a supplementary note that depends upon a plurality of supplementary notes depends upon a supplementary note that depends upon a plurality of supplementary notes. All of the dependency relationships of the supplementary notes expressed below are included in the embodiments.

### Supplementary Note 1

A terminal device (10) comprising a controller (110) and a communicator (120), the controller and the communicator are configured to perform sensing multiple times by exchanging sensing signals applying any of different beams, different frequencies and different signal sequences in the sensing performed multiple times.

### Supplementary Note 2

The terminal device according to supplementary note 1, wherein, the controller and the communicator are further configured to apply same frequencies and different beams in the sensing performed multiple times.

### Supplementary Note 3

The terminal device according to supplementary note 2, wherein, the sensing performed multiple times corresponds to sensing performed n times, the controller and the communicator are further configured to apply different beams in each of the sensing performed m times, and each of n and m are an integer greater than or equal to 2, and n>m.

### Supplementary Note 4

The terminal device according to supplementary note 2 or 3, wherein,
the controller and the communicator are further configured to apply random signal sequences in the sensing performed multiple times.

### Supplementary Note 5

The terminal device according to supplementary note 1, wherein,
the controller and the communicator are further configured to apply different frequencies and different beams in the sensing performed multiple times.

### Supplementary Note 6

The terminal device according to supplementary note 5, wherein,
the sensing performed multiple times corresponds to sensing performed n times,
the controller and the communicator are further configured to apply different beams in each of the sensing performed m times, and
each of n and m are an integer greater than or equal to 2, and n>m.

### Supplementary Note 7

The terminal device according to supplementary note 5 or 6, wherein,
the sensing performed multiple times corresponds to sensing performed n times,
the controller and the communicator are further configured to apply first frequencies to mth frequencies alternately in the sensing performed m times, and
each of n and m are an integer greater than or equal to 2, and n>m.

### Supplementary Note 8

The terminal device according to any of supplementary notes 5 to 7, wherein,
the controller and the communicator are further configured to apply same signal sequences in the sensing performed multiple times.

### Supplementary Note 9

The terminal device according to supplementary note 5, wherein,
the controller and the communicator are further configured to apply random signal sequences in the sensing performed multiple times.

### Supplementary Note 10

The terminal device according to any of supplementary notes 1 to 9, wherein,
the controller and the communicator are further configured to perform the sensing by exchanging the sensing signals using sensing resources allocated in each of the sensing performed multiple times, and
an identifier is assigned in each of the allocated sensing resources.

### Supplementary Note 11

The terminal device according to supplementary note 10, wherein,
the communicator is further configured to notify another device of the assigned identifier in each of the sensing.

### Supplementary Note 12

The terminal device according to supplementary note 10, wherein,
the communicator is further configured to notify another device of the assigned identifier corresponding to each of the sensing.

### Supplementary Note 13

The terminal device according to any of supplementary notes 1 to 12, wherein,
the communicator is further configured to notify another device of a number of sensing corresponding to the sensing performed multiple times.

### Supplementary Note 14

The terminal device according to any of supplementary notes 1 to 12, wherein,
the communicator is further configured to notify another device that subsequent sensing is performed in each of the sensing.

### Supplementary Note 15

The terminal device according to any of supplementary notes 1 to 12, wherein,
the communicator is further configured to notify another device that the sensing performed multiple times ends.

### Supplementary Note 16

The terminal device according to any of supplementary notes 1 to 15, wherein,
the communicator is further configured to notify another device of a sensing parameter corresponding to the sensing performed multiple times.

### Supplementary Note 17

The terminal device according to any of supplementary notes 1 to 15, wherein,
the communicator is further configured to notify another device of a sensing parameter in each of the sensing.

### Supplementary Note 18

The terminal device according to supplementary note 16 or 17, wherein,
the sensing parameter includes any of:
a period for transmitting the sensing signals in a time domain of the sensing resources allocated for the sensing signals.
a period for transmitting the sensing signals and a period for receiving the sensing signals in the time domain of the allocated sensing resources;
frequencies applied for each of the sensing; and
a number of a signal sequence applied for each of the sensing.

### Supplementary Note 19

The terminal device according to any of supplementary notes 1 to 15, wherein,
the sensing resources are allocated for the sensing signals in any combination of a time domain, a frequency domain and a code domain.

### Supplementary Note 20

The terminal device according to supplementary note 19, wherein,
the sensing resources are separated from communication resources used for communication in any combination of a time domain, a frequency domain and a code domain.

### Supplementary Note 21

The terminal device according to supplementary note 20, wherein,
a ratio of allocating resources between the sensing resources and the communication resources changes depending on a predetermined condition.

### Supplementary Note 22

The terminal device according to any of supplementary notes 19 to 21, wherein,
the sensing resources are allocated in a time domain, a period for transmitting the sensing signals and a period for receiving the sensing signals.

### Supplementary Note 23

The terminal device according to supplementary note 22, wherein,
the sensing resources are allocated in a time domain, multiple periods for transmitting the sensing signals and multiple periods for receiving the sensing signals.

### Supplementary Note 24

The terminal device according to supplementary note 22 or 23, wherein,
when transmitting the sensing signals in a transmission scheme of DFTS-OFDM, the period for transmitting the sensing signals corresponds to a sample length.

### Supplementary Note 25

The terminal device according to any of supplementary notes 22 to 24, wherein,
each of the period for transmitting the sensing signals and the period for receiving the sensing signals corresponds to a FFT size.

### Supplementary Note 26

A base station device (20) comprising a controller (210) and a communicator (220),
the controller and the communicator are configured to perform sensing multiple times by exchanging sensing signals applying any of different beams, different frequencies and different signal sequences in the sensing performed multiple times.

### Supplementary Note 27

A method implemented by a terminal device (10) comprising:
performing sensing multiple times by exchanging sensing signals applying any of different beams, different frequencies and different signal sequences in the sensing performed multiple times.

### Supplementary Note 28

A method implemented by a base station device (20) comprising:
performing sensing multiple times by exchanging sensing signals applying any of different beams, different frequencies and different signal sequences in the sensing performed multiple times.

### Supplementary Note 29

A program, when being executed, causing one or more processors in a terminal device (10) to execute:
perform sensing multiple times by exchanging sensing signals applying any of different beams, different frequencies and different signal sequences in the sensing performed multiple times.

### Supplementary Note 30

A program, when being executed, causing one or more processors in a base station device (20) to execute:
perform sensing multiple times by exchanging sensing signals applying any of different beams, different frequencies and different signal sequences in the sensing performed multiple times.

### Supplementary Note 31

A computer-readable non-transitory tangible storage medium storing a program, when being executed, causing one or more processors in a terminal device (10) to execute:
perform sensing multiple times by exchanging sensing signals applying any of different beams, different frequencies and different signal sequences in the sensing performed multiple times.

### Supplementary Note 32

A computer-readable non-transitory tangible storage medium storing a program, when being executed, causing one or more processors in a base station device (20) to execute:
perform sensing multiple times by exchanging sensing signals applying any of different beams, different frequencies and different signal sequences in the sensing performed multiple times.

Note that the disclosures in the prior art documents and the cited references are incorporated herein by reference in the present application.

What is claimed is:

1. A terminal device comprising:
a memory storing instructions; and
one or more processors configured to execute the instructions to:
perform sensing multiple times by exchanging sensing signals applying any of different beams, different frequencies and different signal sequences in the sensing performed multiple times.

2. The terminal device according to claim 1, wherein,
the one or more processors are further configured to apply same frequencies and different beams in the sensing performed multiple times.

3. The terminal device according to claim 2, wherein,
the sensing performed multiple times corresponds to sensing performed n times,
the one or more processors are further configured to apply different beams in each of the sensing performed m times, and
each of n and m are an integer greater than or equal to 2, and n>m.

4. The terminal device according to claim 2, wherein,
the one or more processors are further configured to apply random signal sequences in the sensing performed multiple times.

5. The terminal device according to claim 1, wherein,
the one or more processors are further configured to apply different frequencies and different beams in the sensing performed multiple times.

6. The terminal device according to claim 5, wherein,
the sensing performed multiple times corresponds to sensing performed n times,
the one or more processors are further configured to apply different beams in each of the sensing performed m times, and
each of n and m are an integer greater than or equal to 2, and n>m.

7. The terminal device according to claim 5, wherein,
the sensing performed multiple times corresponds to sensing performed n times,
the one or more processors are further configured to apply first frequencies to mth frequencies alternately in the sensing performed m times, and
each of n and m are an integer greater than or equal to 2, and n>m.

8. The terminal device according to claim 5, wherein,
the one or more processors are further configured to apply same signal sequences in the sensing performed multiple times.

9. The terminal device according to claim 5, wherein,
the one or more processors are further configured to apply random signal sequences in the sensing performed multiple times.

10. The terminal device according to claim 1, wherein,
the one or more processors are further configured to perform the sensing by exchanging the sensing signals using sensing resources allocated in each of the sensing performed multiple times, and
an identifier is assigned in each of the allocated sensing resources.

11. The terminal device according to claim 10, wherein,
the one or more processors are further configured to notify another device of the assigned identifier in each of the sensing.

12. The terminal device according to claim 10, wherein,
the one or more processors are further configured to notify another device of the assigned identifier corresponding to each of the sensing.

13. The terminal device according to claim 1, wherein,
the one or more processors are further configured to notify another device of a number of sensing corresponding to the sensing performed multiple times.

14. The terminal device according to claim 1, wherein,
the one or more processors are further configured to notify another device that subsequent sensing is performed in each of the sensing.

15. The terminal device according to claim 1, wherein,
the one or more processors are further configured to notify another device that the sensing performed multiple times ends.

16. The terminal device according to claim 1, wherein,
the one or more processors are further configured to notify another device of a sensing parameter corresponding to the sensing performed multiple times.

17. The terminal device according to claim 1, wherein,
the one or more processors are further configured to notify another device of a sensing parameter in each of the sensing.

18. The terminal device according to claim 16, wherein,
the sensing parameter includes any of:
a period for transmitting the sensing signals in a time domain of the sensing resources allocated for the sensing signals.
a period for transmitting the sensing signals and a period for receiving the sensing signals in the time domain of the allocated sensing resources;
frequencies applied for each of the sensing; and
a number of a signal sequence applied for each of the sensing.

19. A method implemented by a terminal device comprising:
performing sensing multiple times by exchanging sensing signals applying any of different beams, different frequencies and different signal sequences in the sensing performed multiple times.

20. A computer-readable non-transitory tangible storage medium storing a program, when being executed, causing one or more processors in a terminal device to execute:
perform sensing multiple times by exchanging sensing signals applying any of different beams, different frequencies and different signal sequences in the sensing performed multiple times.
